(19) United States
(12) Patent Application Publication
(10) Pub. No.: US 2023/0314728 A1
(43) Pub. Date: Oct. 5, 2023

(54) FIBER OPTIC ENCLOSURE WITH A SIDE CABLE ENTRANCE

(71) Applicant: CommScope Technologies LLC, Hickory, NC (US)

(72) Inventors: Bart Mattie Claessens, Hasselt (BE); Philippe Coenegracht, Hasselt (BE); Johan Geens, Bunsbeek (BE); Pieter Vermeulen, Westerlo (BE); Karel Vanwinkel, Tielt-Winge (BE); Dirk Jozef G. VAN DE WEYER, Beringen (BE); Geert Van Genechten, Vorselaar (BE)

(21) Appl. No.: 18/041,672

(22) PCT Filed: Aug. 13, 2021
(86) PCT No.: PCT/US2021/045943

§ 371 Date: Feb. 14, 2023

Related U.S. Application Data
(60) Provisional application No. 63/232,522, filed on Aug. 12, 2021.
(60) Provisional application No. 63/065,875, filed on Aug. 14, 2020.

(51) Int. Cl. G02B 6/38; G02B 6/44

(52) U.S. Cl. CPC G02B 6/3897; G02B 6/4444

(57) ABSTRACT

A telecommunications enclosure includes an extension defining a side cable entrance. In certain enclosures, the housing is elongate along a length and the extension is disposed at one end of the length. Cable sealing (e.g., gel) is disposed in the cable extension. One or more pivotal splice trays may be mounted within the housing. Loop storage also may be provided at or near the side cable entrance.

### CROSS-REFERENCE TO RELATED APPLICATION

This application is being filed on Aug. 13, 2021 as a PCT International Patent Application and claims the benefit of U.S. Patent Application Ser. Nos. 63/065,875, filed on Aug. 14, 2020; and 63/232,522, filed Aug. 12, 2021; the disclosures of which are incorporated herein by reference in their entireties.

### TECHNICAL FIELD

The present disclosure relates generally to telecommunications processes and devices. More particularly, the present disclosure relates to a telecommunications enclosure.

### BACKGROUND

Telecommunications systems typically employ a network of telecommunications cables capable of transmitting large volumes of data and voice signals over relatively long distances. The telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures are adapted to house and protect telecommunications components such as splices, termination panels, power splitters and wavelength division multiplexers. It is often preferred for the telecommunications enclosures to be re-enterable. The term “re-enterable” means that the telecommunications enclosures can be reopened to allow access to the telecommunications components housed therein without requiring the removal and destruction of the telecommunications enclosures. For example, certain telecommunications enclosures can include separate access panels that can be opened to access the interiors of the enclosures, and then closed to re-seal the enclosures. Other telecommunications enclosures take the form of elongated sleeves formed by wrap-around covers or half-shells having longitudinal edges that are joined by clamps or other retainers. Still other telecommunications enclosures include two half-pieces that are joined together through clamps, wedges or other structures. Still other enclosures include domes detachably secured to bases by latches or clamps.

Telecommunications enclosures are typically sealed to inhibit the intrusion of moisture or other contaminants. Pressurized gel-type seals have been used to effectively seal the locations where telecommunications cables enter and exit telecommunications enclosures. Example pressurized gel-type seals are disclosed by document EP 0442941 B1 and document EP 0587616 B1. Both of these documents disclose gel-type cable seals that are pressurized through the use of threaded actuators. Document U.S. Pat. No. 6,046,406 discloses a cable seal that is pressurized through the use of an actuator including a cam lever.

Telecommunications enclosures can be placed in the field in underground spaces. The underground spaces are typically fairly small. Often the enclosures are elongate and cables exit/enter the enclosures in axial orientations through ends of the enclosures. When coiled storage of excess cable is required outside enclosures of the above type, the enclosures combined with the coiled cable can occupy a relatively large space thereby presenting difficulties for use in small spaces such as underground hand-holes. Improvements are desired.

### SUMMARY

Some aspects the present disclosure relate to a telecommunications enclosure. The telecommunications enclosure can include a housing having a dome and a base positioned at one end of the dome. In certain examples, at least a portion of the base is detachable from a remainder of the housing. In one example, the housing includes a side cable entrance defined at least in part by the base. In one example, the housing is elongate along a length that extends along a longitudinal axis of the housing. The cable entrance opens along a cable entrance axis aligned in a reference plane that extends across the longitudinal axis. The housing defines a cross-dimension that is perpendicular to the longitudinal axis, the cross-dimension being measured at the side cable entrance and the length of the housing being longer than the cross-dimension.

In some aspects, the housing includes a sleeve which defines the side cable entrance. The sleeve includes a sleeve passage containing a cable sealing unit including cable sealing gel. In some examples, the cable sealing unit is coupled to a base tray that extends along the reference plane.

In some examples, the dome defines a first volume positioned on a first side of the reference plane and the base defines a second volume on a second side of the plane opposite from the first side. In one aspect a plurality of pivotal splice trays are located in the first volume and a loop-storage manager for storing optical fiber in a coil is located in the second volume.

In one aspect, the telecommunications enclosure can include a base tray that extends into the housing, the base tray can include cable anchoring locations for anchoring cables routed into the housing through the side cable entrance.

In one aspect, the base tray can support a tower that extends into the dome. The pivotal splice trays are supported by the tower.

### BRIEF DESCRIPTION OF THE DRAWINGS

FIG. 1A is a schematic diagram of a prior art telecommunications enclosure with an exterior coil of cable providing cable storage adjacent the enclosure;

FIG. 1B is a schematic diagram of a telecommunications enclosure in accordance with the principles of this disclosure with an exterior coil of cable providing cable storage adjacent the enclosure;

FIG. 2 is a schematic diagram of another telecommunications enclosure in accordance with the principles of this disclosure;

FIG. 3 is a schematic diagram of the telecommunications enclosure of FIG. 2 highlighting the internal components;

FIG. 4 is another schematic view of the telecommunications enclosure of FIG. 2;

FIG. 5 is cross-sectional view taken along section line 5-5 of FIG. 4,

FIG. 6 is a schematic diagram of another telecommunications enclosure in accordance with the principles of the present disclosure;

FIG. 7 is cross-sectional view taken along section line 7-7 of FIG. 6;

FIG. 8 is a perspective view of example internal components that can be incorporated within the telecommunications enclosures of FIG. 1B, 2 or 6;

FIG. 9 is a rear perspective view of the internal components of FIG. 8;

FIG. 10 is a sealing sleeve in accordance with the principles of this disclosure which can be used in the telecommunications enclosures of FIG. 1B, 2 or 6;

FIG. 11 is a cable anchoring and sealing unit in accordance with the principles of this disclosure which can be used in the telecommunications enclosures of FIG. 1B, 2 and 6;

FIG. 12 is a top, schematic view of the telecommunications enclosure of FIG. 2 showing a pass-through cable installed within the enclosure;

FIG. 13 is a perspective view of a different telecommunications enclosure in accordance with the principles of this disclosure;

FIG. 14 is another perspective view of the telecommunications enclosure of FIG. 13;

FIG. 15 is a front and side view of the telecommunications enclosure of FIG. 13;

FIG. 16 is a front view of the telecommunications enclosure of FIG. 13;

FIG. 17 is a side view of the telecommunications enclosure of FIG. 13;

FIG. 18 is another side view of the telecommunications enclosure of FIG. 13 opposite from the side view of FIG. 17;

FIG. 19 is a top view of the telecommunications enclosure of FIG. 13;

FIG. 20 a perspective view of the telecommunications enclosure of FIG. 13 with a cover and portion of a base removed showing a first plurality of trays mounted to a tray tower having a first configuration;

FIG. 21 is a front view of the telecommunications enclosure of FIG. 20;

FIG. 22 is a top view of the telecommunications enclosure of FIG. 20;

FIG. 23 is a cross-sectional view showing a cable sealing arrangement of the enclosure of FIG. 13 in a non-pressurized state;

FIG. 24 is a cross-sectional view showing the cable sealing arrangement of the enclosure of FIG. 13 in a pressurized state;

FIG. 25 is another perspective view of the telecommunications enclosure of FIG. 13 showing a retaining element of the cable sealing arrangement and with cable sealing gel removed from the sealing arrangement so that pressurization/containment structures between which the gel is pressurized are better visible;

FIG. 26 shows a portion of the base of the enclosure of FIG. 13 with a base tray installed therein and the trays removed from the tray tower;

FIG. 27 depicts the view of FIG. 26 with the tray tower removed;

FIG. 28 a perspective view showing an alternative arrangement mountable in the housing of the enclosure of FIG. 13, the alternative arrangement includes a second plurality of trays mounted to a tray tower having a second configuration;

FIG. 29 is a top view of the telecommunications enclosure of FIG. 24;

FIG. 30 is a rear view of the arrangement of FIG. 20 showing a rear fiber storage module mounted to the tray tower having the first configuration;

FIG. 31 depicts a first side of the rear fiber storage module;

FIG. 32 depicts an opposite second side of the rear fiber storage module of FIG. 31;

FIG. 33 is a bottom view of the rear fiber storage module of FIGS. 31 and 32;

FIG. 34 is a perspective view of the tray tower having the first configuration;

FIG. 35 is a rear view of the tray tower having the first configuration with a first tray adapter installed on the tray tower in place of the rear fiber storage module for increasing a tray capacity of the tray tower;

FIG. 36 is a perspective view of the first tray adapter;

FIG. 37 is a rear view of the tray tower having the first configuration with a second tray adapter installed on the tray tower for increasing a tray capacity of the tray tower;

FIG. 38 is a perspective view of the second tray adapter;

FIG. 39 is a perspective view of a base tray of the enclosure of FIG. 13;

FIG. 40 is side view of the base tray of FIG. 39;

FIG. 41 is a top view of the base tray of FIG. 39; and

FIG. 42 is a cross-sectional view showing a feeder cable routed though the cable sealing arrangement of the enclosure of FIG. 13.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

Certain aspects of the present disclosure relate to systems, methods and enclosure configurations for enhancing a telecommunications enclosure for enhanced use in the field and in order to satisfy customer and factory requirements. In certain examples, the use of the telecommunications enclosure can be enhanced by providing a side entrance for cables. The provision of a side cable entrance for cables to pass through allows for more compact coiled storage of cable outside the enclosure and effective cable/fiber management within the enclosure. In one example, the enclosure includes a dome and a base, with the side cable entrance being defined at least in part by the base. In one example, the side cable entrance includes a cable sealing arrangement including a sealing material such as a volume of sealing gel. In one example, the cable sealing arrangement can be pressurized by an actuator.

In one example, the enclosure has a housing having a main housing body that is elongate along a length that extends along a longitudinal axis of the main housing body between first and second ends, and the enclosure has a side cable entrance adjacent one of the first and second ends. In one example, cables entering the enclosure through the side cable entrance extend along a cable entrance orientation that is not parallel to the longitudinal axis. In one example, the cable entrance location includes a cable sealing arrangement. In one example, the cable sealing arrangement is positioned within a cable entrance extension that projects laterally from the main housing body adjacent the end of the main housing body. In one example, the cable sealing arrangement can include a volume of gel and an actuator for pressurizing the gel within the cable entrance extension. In one example, a majority of the length of the main housing body is defined by a cover (e.g., dome) that removably mounts to a base of the enclosure. In one example, the cable entrance locations is configured to receive a plurality of cable at cable pass-through locations distributed along a cable entrance reference plane which is parallel to cable pass-through orientation of the cables, and wherein the cable entrance reference plane extends across and is not parallel to the longitudinal axis of the main housing body. In one example, the cable entrance reference plane is angled in the range of 60-120 degrees relative to the longitudinal axis, or in the range of 80-100 degrees relative to the longitudinal axis, or in the range of 85-95 degrees relative to the longitudinal axis, or is perpendicular relative to the longitudinal axis. In one example, from a side view, the cable entrance extension is angled in the range of 60-120 degrees relative to the main housing body, or in the range of 80-100 degrees relative to the main housing body, or in the range of 85-95 degrees relative to the main housing body, or is perpendicular relative to the main housing body. In one example, from an end view along the longitudinal axis of the main housing body, the cable entrance extension is angled in the range of 100-175 degrees relative to the main housing body, or in the range of 110-170 degrees relative to the main housing body, or in the range of 130-170 degrees relative to the main housing body.

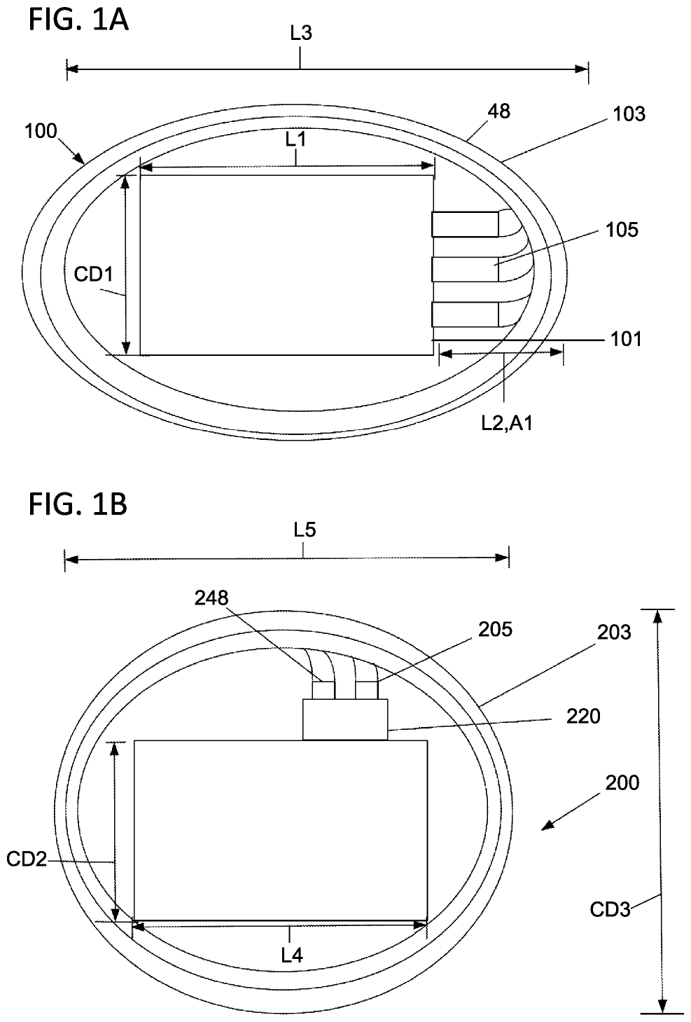

FIGS. 1A and 1B are schematic diagrams of exterior cable coil storage arrangements for coiling excess cable about corresponding enclosures. In the depicted examples, the coiling is schematically shown and cable bends can be exaggerated from what would actually be provided in practice. FIG. 1A shows a prior art telecommunications enclosure 100. The telecommunications enclosure 100 of FIG. 1A has a length L1 and a cross-dimension CD1. The length L1 is substantially longer than the cross-dimension CD1. Cables 48 such as fiber optic cables are routed into the telecommunications enclosure 100 through an axial end 101 of the enclosure in an axial direction A1 that extends along the housing length L1. Excess cable outside the telecommunications enclosure 100 can be arranged in a coil 103 for storage. The cables 48 exiting/entering the enclosure through the axial end 101 of the telecommunications enclosure 100 must gradually transition along a transition region 105 from an in-line orientation to the coil 103 along a gradual curve. The transition should be in compliance with bend radius requirements of the cable and therefore can't be a sharp curve or kink. Hence, the transition region 105 has a significant axial length L2. The additive result of the housing length L1 and the axial length L2 of the transition region 105 from the axial end 101 of the telecommunications enclosure 100 to the coil 103 causes a total length L3 (e.g., a maximum length or cross-dimension) of the enclosure and the coil to be relatively long and possibly difficult to store in a small space such as a hand-hole.

Referring to FIG. 1B, a schematic diagram of a telecommunications enclosure 200 in accordance with the principles of this disclosure is shown. The telecommunications enclosure 200 extends along a length L4. Rather than an end cable entrance, the telecommunications enclosure includes a side cable entrance 220 for allowing cables 248 to be routed in/out of the telecommunications enclosure 200. Excess length of the cables 248 is stored in a coil 203 outside the telecommunications enclosure 200. The cables 248 entering/exiting the telecommunications enclosure 200 transition along a transition region 205 from a lateral orientation to the coil 203. The lateral orientation extends along a cross-dimension CD2 of the telecommunications enclosure 200 which is smaller than the axial length L4 of the enclosure. Because the transition region is oriented in the lateral orientation, it does not add axial length to the assembly. Hence, a total length L5 of the telecommunications enclosure 200 and the coil 203 is less than the total length L3 of the telecommunications enclosure 100 and the coil 103. Additionally, a cross-dimension CD3 of the telecommunications enclosure 200 and the coil 203 is less than the total length L3 of the telecommunications enclosure 100 and the coil 103.

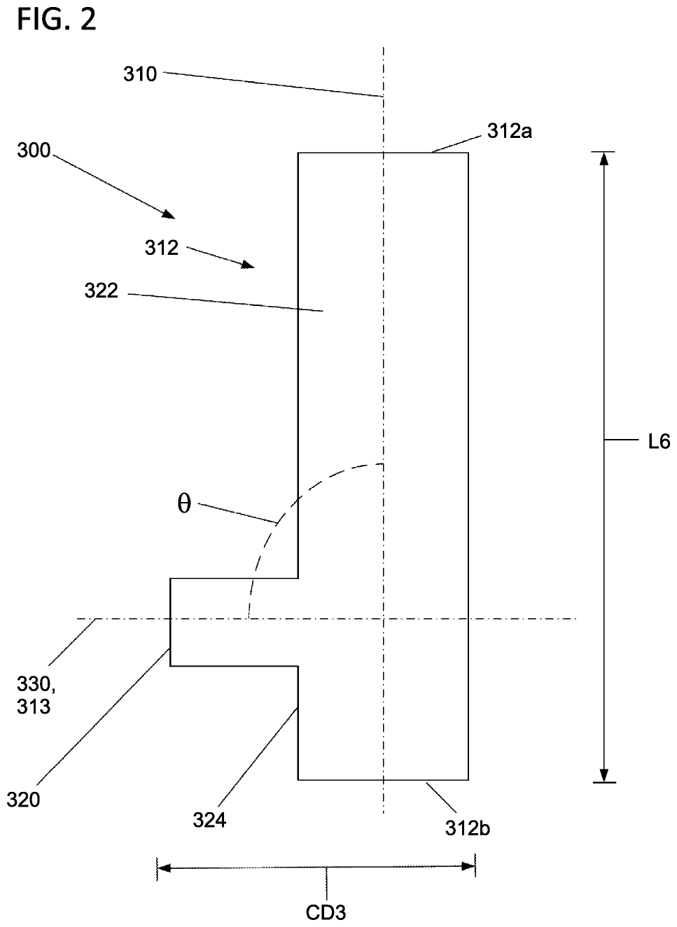

A schematic diagram of another telecommunications enclosure 300 in accordance with the principles of this disclosure is shown in FIG. 2. The schematic diagram shows the telecommunications enclosure 300 featuring a housing 312. The housing 312 includes a dome 322 positioned at a first end 312a of the housing 312 and a base 324 positioned at a second end 312b of the housing 312. The housing 312 is also shown extending along a length L6 between the first and second ends 312a, 312b of the housing 312 along a longitudinal axis 310. FIG. 2 is a side view of the enclosure.

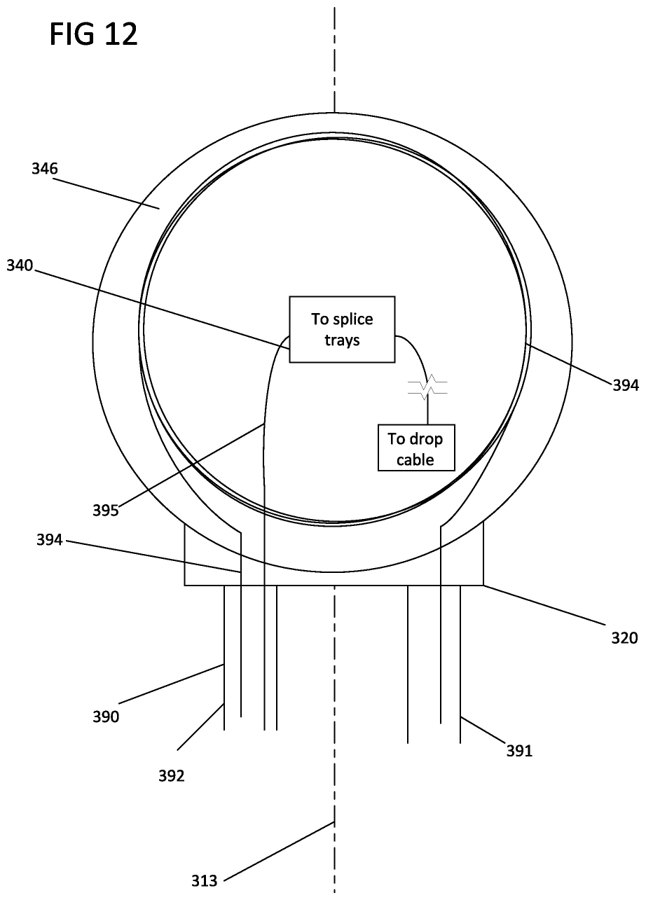

The housing 312 includes a side cable entrance 320. The side cable entrance 320 defines a cable entrance axis 313 (see FIGS. 2 and 12) aligned in a reference plane 330 (see FIG. 2) that extends across the longitudinal axis 310. The housing 312 defines the cross-dimension CD3 that is perpendicular to the longitudinal axis 310. The cross-dimension CD3 is measured at the side cable entrance 320. In some examples, the length L6 of the housing 312 is longer than the cross-dimension CD3. In some examples, the length L6 can be at least 2 or 3 times as long as the cross-dimension CD3. In some examples, the reference plane 330 is perpendicular to the longitudinal axis 310. In other examples the reference plane 330 is oriented at an angle θ measured with respect to the longitudinal axis 310. In certain examples, the angle θ is preferably in a range between 60-120 degrees or 45-135 degrees.

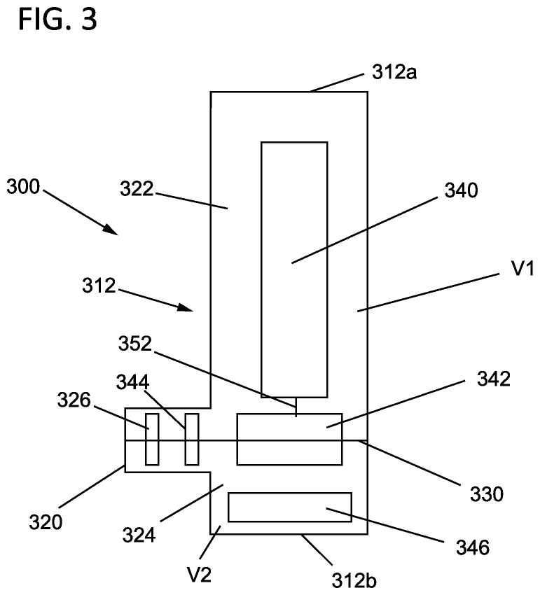

FIG. 3 is a schematic diagram of the telecommunications enclosure 300 depicting components on the interior of the telecommunications enclosure 300. The telecommunications internal components include a tower 352, a plurality of splice trays 340 supported by the tower 352 (e.g., pivotally coupled to the tower), a base tray 342 supporting the tower 352, a cable sealing unit 326 optionally coupled to the base tray 342 and positioned at the side cable entrance 320, a cable anchoring location 344 optionally supported on the base tray 342 between the cable sealing unit 326 and the tower 352, and a loop fiber storage area 346 located at a side of the base tray 342 opposite from the tower 352. The loop fiber storage area 346 can include a basket, tray, spool, ring, or the like for managing and coiling optical fiber and/or optical cable.

The base 324 and the dome 322 of the telecommunications enclosure 100 can include volumes (e.g., regions, section, etc.) separated by the base tray 342. For example, the dome 322 includes a first volume V1 positioned at the first side of the reference plane 330 adjacent to the first end 312a of the housing 312. The base 324 includes a second volume V2 adjacent to the second end 312b of the housing 312. The first and second volumes are divided by the reference plane 330.

The base 324 and the dome 322 can be separate pieces coupled together by detachable connections and each of the base 324 and the dome 322 can include one or more pieces. For example, in some embodiments the base is made from a top piece and a bottom piece. In one example, the base is a made from a top and a bottom base piece and the dome is a separate piece which can be removably attached to the top base piece. In another example, the base is a made from a top and a bottom base piece that are detachable from one another and a lower end of the dome is unitarily connected with an upper end of the top base piece. The detachable connections can be provided by latches, one or more clamps or the like.

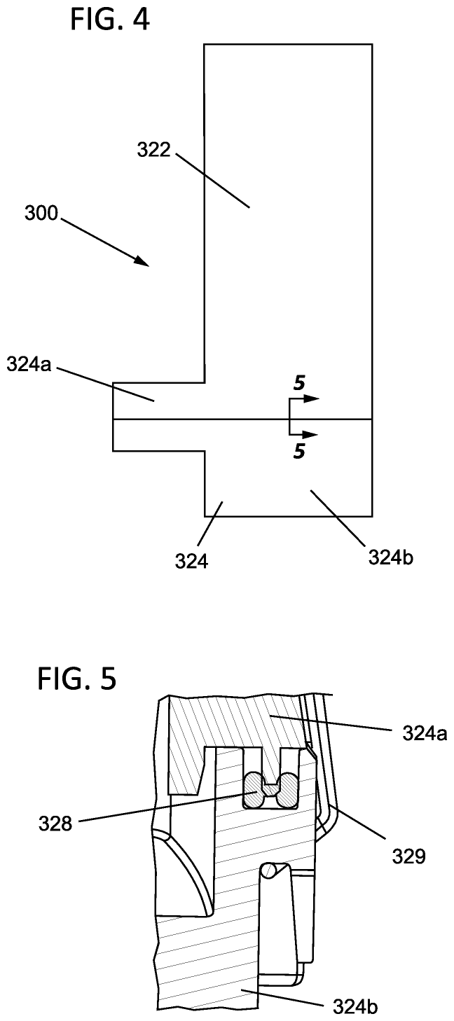

Referring to FIG. 4, the base 324 of the telecommunications enclosure 300 includes a top piece 324a and a bottom base piece 324b that are detachable from one another and a lower end of the dome 322 is unitarily connected with an upper end of the top base piece 324b. The ability to separate the top and bottom base pieces 324a, 324b provides enhanced access to the cable sealing unit 326 for routing cable through the cable sealing unit 326 or removing cable from the sealing unit 326. A sealed, detachable connection interface preferably is provided between the top and bottom base pieces 324a, 324b. For example, as shown at FIG. 5, an H-shaped seal 328 is provided between the top and bottom base pieces 324a, 324b (e.g., the seal provides sealing about a perimeter of the mated pieces). This interface can be detached to provide access to the sealing unit 326 as well as the first and second volumes V1, V2. The top and bottom base pieces 324a, 324b can be detachably coupled together attached using a fastening system 329 that may include one or more clamps or latches.

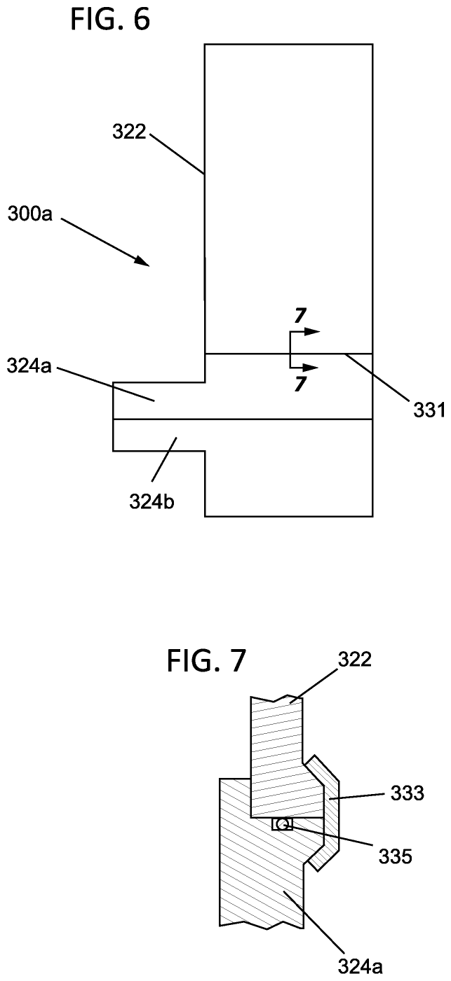

FIGS. 6 and 7 depict an alternative enclosure 300a having the same configuration as the telecommunications enclosure 300 except a sealed, detachable interface 331 has been provided between the dome 322 and the top base piece 324a. The ability to detach the dome 322 from the top base piece 324a allows the volume V1 to be accessed without disturbing the sealing unit 326. The detachable interface 331 is sealed by a sealing element such as an O-ring seal 333 or other type of perimeter seal (e.g., an H-shaped seal) and a fastening system including a clamp such as a v-band clamp 335 or latches.

Though an H-shaped seal 328 and an O-ring seal 333 are shown in the embodiments discussed above, other shaped seals can be used to provide perimeter sealing between the different mating pieces of the enclosure. Additionally, it is within the scope of this disclosure for there to be different types of fastening systems for holding the different pieces of the dome and the base together.

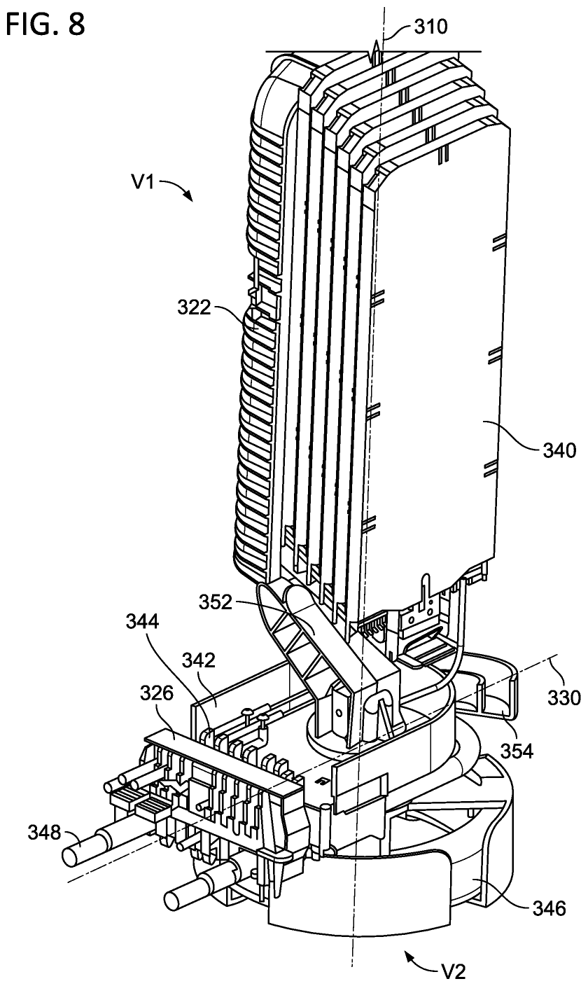

In FIG. 8, the internal components of the telecommunications enclosure 300 are shown in more detail including the cable anchoring unit 344, the tower 352, the cable sealing unit 326, the base tray 342, the loop fiber storage area 346, the plurality of splice trays 340, and a routing channel 354 for routing fibers from a level defined by the base tray 342 toward the trays 340 in the dome 322. One or more additional channels can be provided for routing optical fibers from the base tray 342 to loop storage area. The internal components are shown in the first and second volume V1, V2 which are separated by the base tray 342.

The base tray 342 is shown oriented transverse to the longitudinal axis 310 and extending along the reference plane 330. The base tray 342 supports the tower 352 and the cable anchoring unit 344 and can be configured to manage fiber routing. In some examples, the cable sealing unit 326 is coupled to the base tray 342.

The plurality of pivotal splice trays 340 in are shown in the first volume V1 of the telecommunications enclosure 300, located above the reference plane 330 and the base tray 342. The pivotal splice trays 340 allow for fiber storage, fiber management, splice management as well as splice and fiber protection. Additional uses of the pivotal splice trays 40 can be mounting of passive optical splitters or WDM (wavelength division multiplexer) devices. The use of the pivotal splice trays 340 depends on the desired use by the end user. The plurality of pivotal splice trays 340 can be attached and supported by the tower 352. A base end of the tower 352 can be anchored to the base tray 342.

The optical fibers stored and used in the pivotal splice trays 340 correspond to optical cables 348 that enter the telecommunications enclosure 300 through the side cable entrance 320. The fiber optic cables 348 can be anchored to the base at the cable anchoring region and can be sealed relative to the telecommunications enclosure 300 by the cable sealing unit 326. The side cable entrance 320 can be defined by a sleeve 303 that projects laterally from a main body of the base 324. The sleeve 303 can have an elongate transverse cross-sectional shape and can be configured to receiving the sealing unit 326. The sealing unit 326 can include gel or other sealant that seals against an inner surface of the sleeve and also provide sealing about each of the cables 348 routed through the side cable entrance 320.

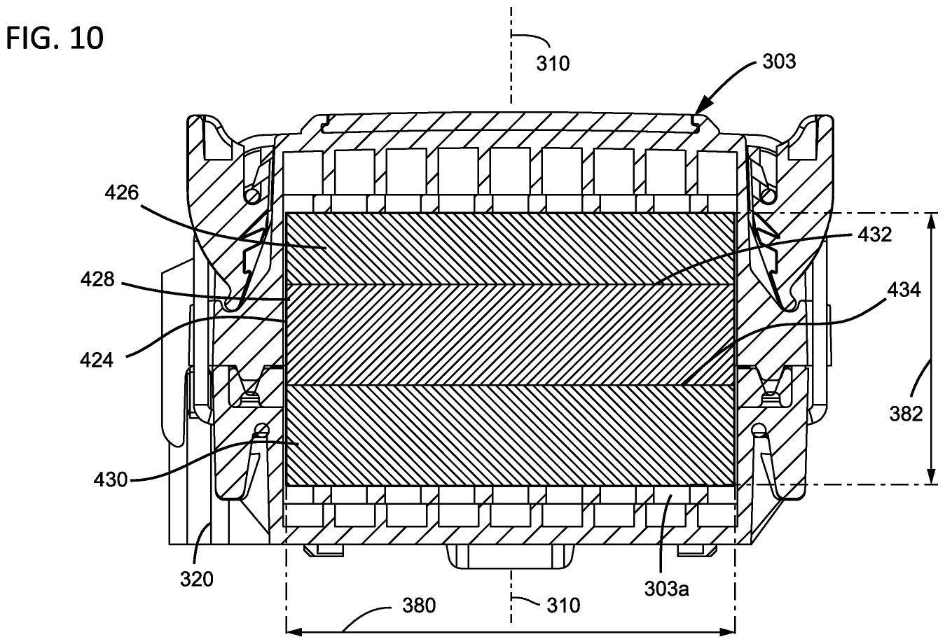

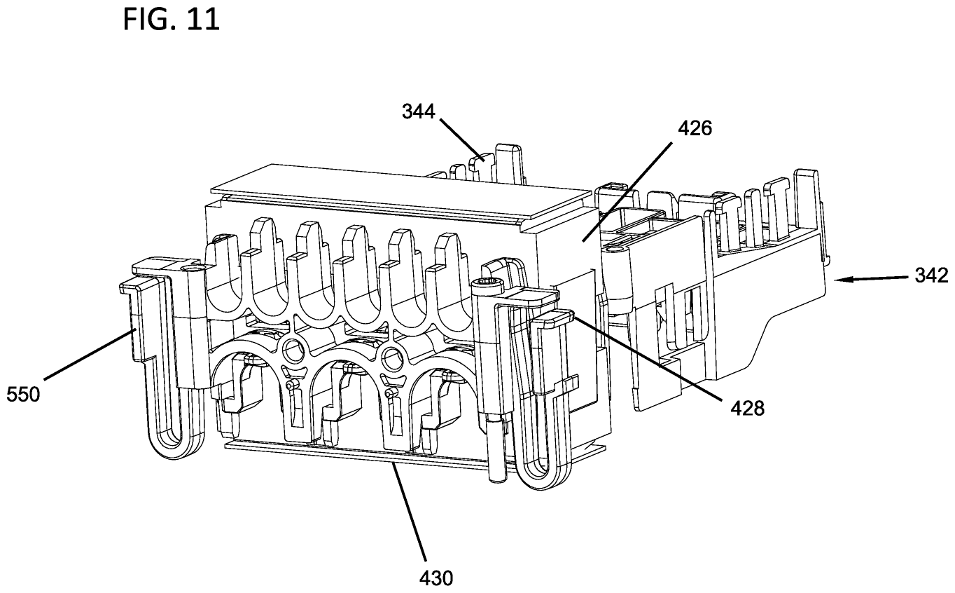

An example cable sealing unit 326 (e.g., a cable sealing arrangement) adapted to fit within the sleeve 303 is shown in FIG. 10. The sealing unit includes a volume of gel 424 optionally including first, second and third gel sections 426, 428, 430. The second gel section 428 is between the first and second gel sections 426, 430. The cable sealing unit 326 includes a first cable pass-through location 432 defined at an interface between the first and second gel sections 426, 428; and a second cable pass-through location 434 defined at an interface between the second and third gel sections 428, 430. FIG. 8 shows the cable sealing unit 326 coupled to the base tray 342.

In some embodiments, the sleeve 303 can have an inner profile 303a. The inner profile 303a has a major dimension 380 and a minor dimension 382. The minor dimension 382 can be perpendicular to the major dimension 380. In some examples, the minor dimension 382 is at least 30, 40 or 50% as large as the major dimension 180. In some examples, the minor dimension 382 is parallel to the longitudinal axis 310 and the major dimension 380 is parallel to the reference plane 330.

Examples of gels used in cable sealing units can include silicone gel or thermoplastic elastomer gels. The gels can be pressurized about the fiber optic cables 348 thus providing a seal and not allowing liquid or foreign materials to enter the telecommunications enclosure 300. In some examples, the gel can be pressurized with an actuator, in other examples the gel can be pressurized without an actuator.

FIG. 11 shows the cable sealing unit 326, as described above, mounted between the base tray 342 and the cable anchoring location 344.

Cables routed through the side cable entrance 320 can include drop cables and pass-through cables. Drop cables can be spliced to fibers of pass-through cables within the enclosure. FIG. 12 shows an example pass through cable 390 having an input section 391 and an output section 392 routed through the side cable entrance 320. The input and output sections 391, 392 can be anchored to the enclosure at the anchoring location. A portion of a jacket of the pass-through cable 390 can be removed to expose a length of optical fibers. The optical fibers can include pass through fibers 394 that are uncut and that extend through the telecommunications enclosure 300 from the input section 391 to the output section 392. The pass-through fibers 394 can be arranged in a coil and stored to the loop fiber storage area 346. The optical fibers can also include accessed fibers 395 that are cut and routed through the telecommunications enclosure 300 to the splice trays 340. At the splice trays, the fibers 395 can be optically coupled to fibers of drop cable or to the input sides of optical devices such as passive optical power splitters or WDM's.

Cables are anchored to the enclosure (e.g., to the base tray) at the cable anchoring location 344. The cable anchoring location 344 incudes structure for anchoring the cables with cable ties, clamps, anchoring blades fasteners or other similar means.

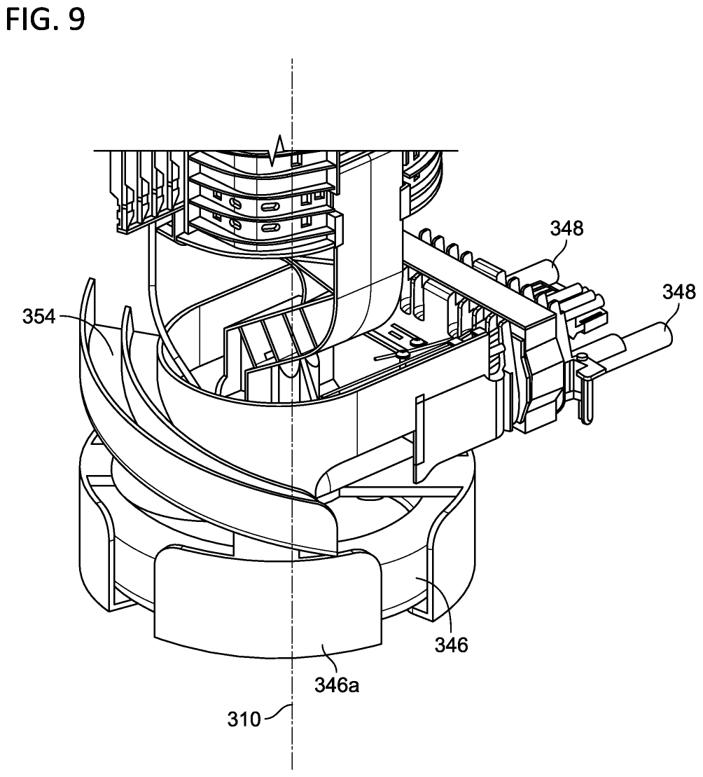

A next aspect of the telecommunications enclosure 300 relates to the routing channels 354 for guiding optical fibers from the base tray into the first volume V1 where the splice trays 340 are located. The fiber routing channels 354 are shown in more detail in FIG. 9. The fiber routing channels 354, in this particular embodiment, begin facing the side cable entrance 320 (e.g., the cable sealing unit 326) and then extend in a curve upwards path about the longitudinal axis 310 towards the pivotal splice trays 340 allowing the optical fibers to travel from the cables 348 to the splice trays.

An additional aspect of the telecommunications enclosure 300 is the fiber storage area 346. The fiber storage area 346 allows for storage of pass-through optical fibers or other optical fibers from the fiber optic cables 348 as the fibers pass through the telecommunications enclosure 300. The fiber storage location 346 is shown, in this particular embodiment, below the base tray 342 in the second volume V2.

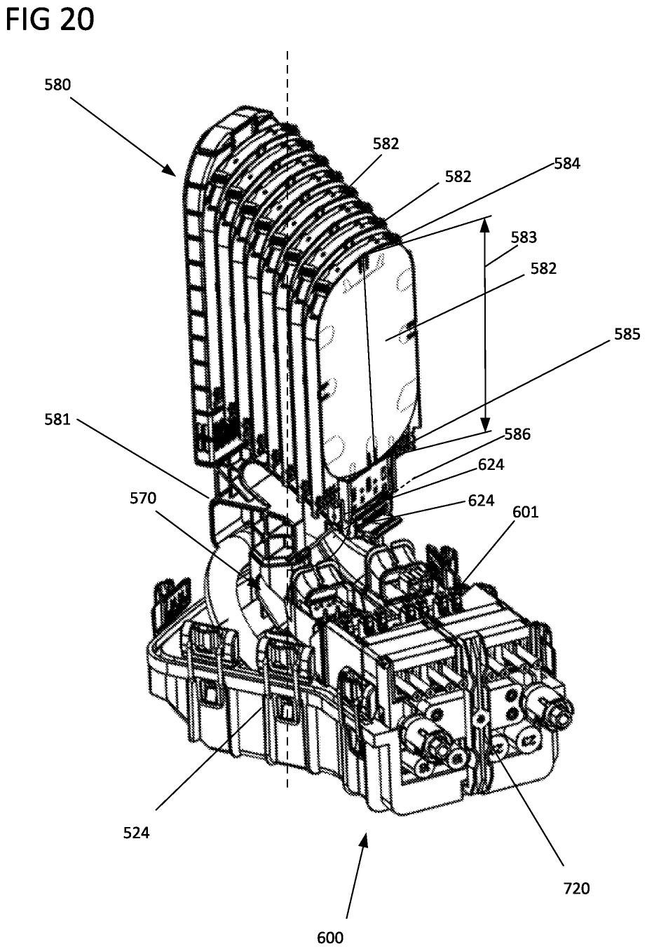

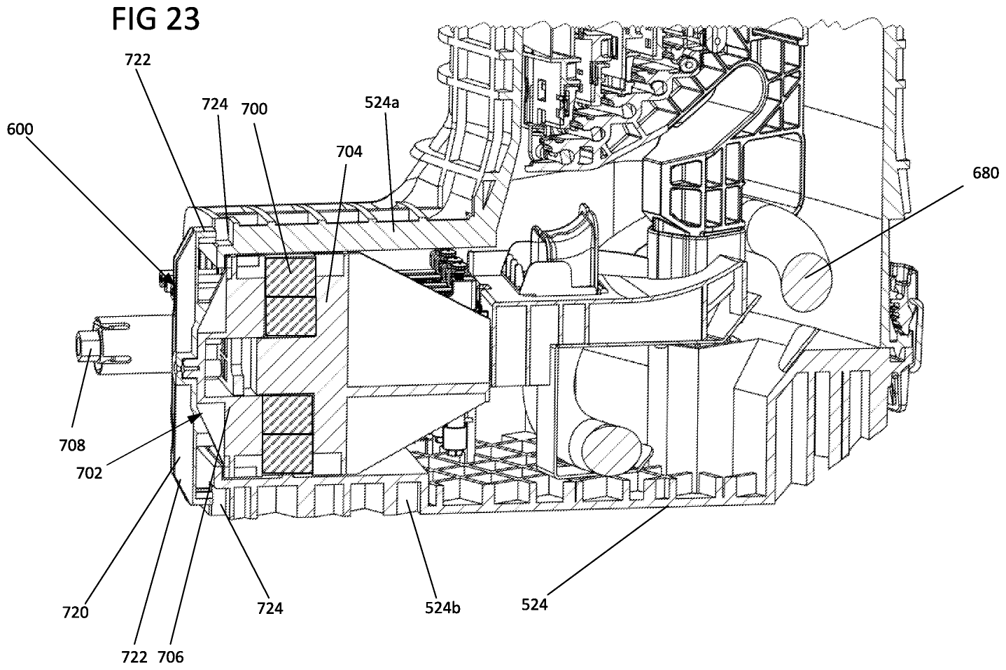

In the embodiment shown, the fiber storage location 346 includes a fiber storage device and includes circumferentially spaced pieces 346a (e.g., curved outer guide walls) which provide containment for excess optical fiber that is stored in a loop/coil within. Fiber management guides (e.g., fingers, partial spools, curved guides, bend radius protectors, walls, etc.) define a fiber loop storage path (shown schematically via ring structure 347 representative of the fiber storage loop path). The fiber loop storage path can be aligned generally along a plane obliquely angled relative to the longitudinal axis of the enclosure (see example of FIGS. 20 and 23) or that is aligned perpendicular relative to the longitudinal axis of the enclosure (see FIG. 8).

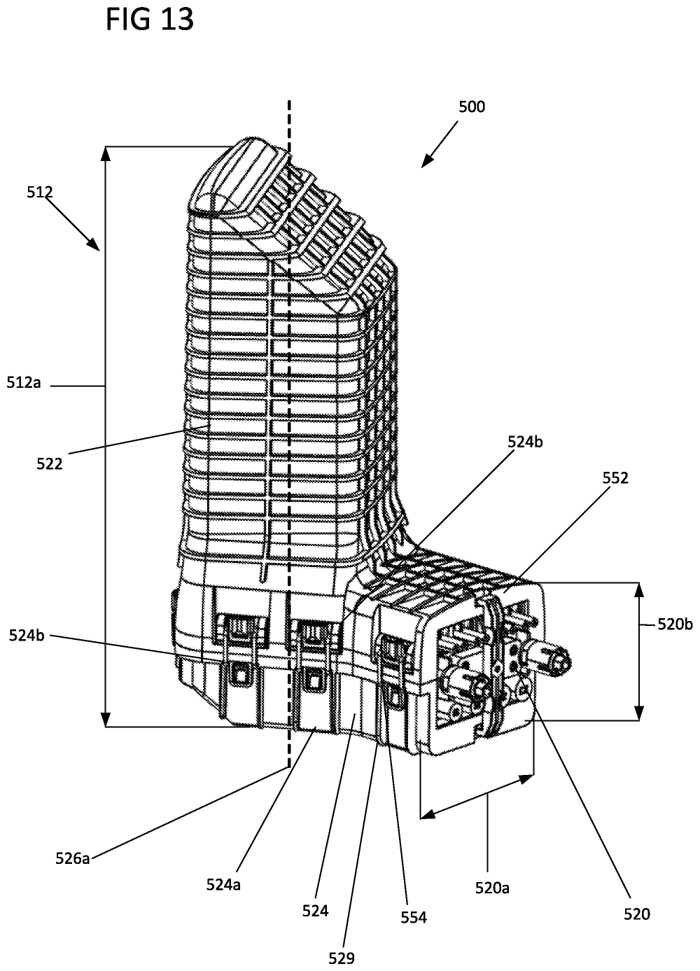

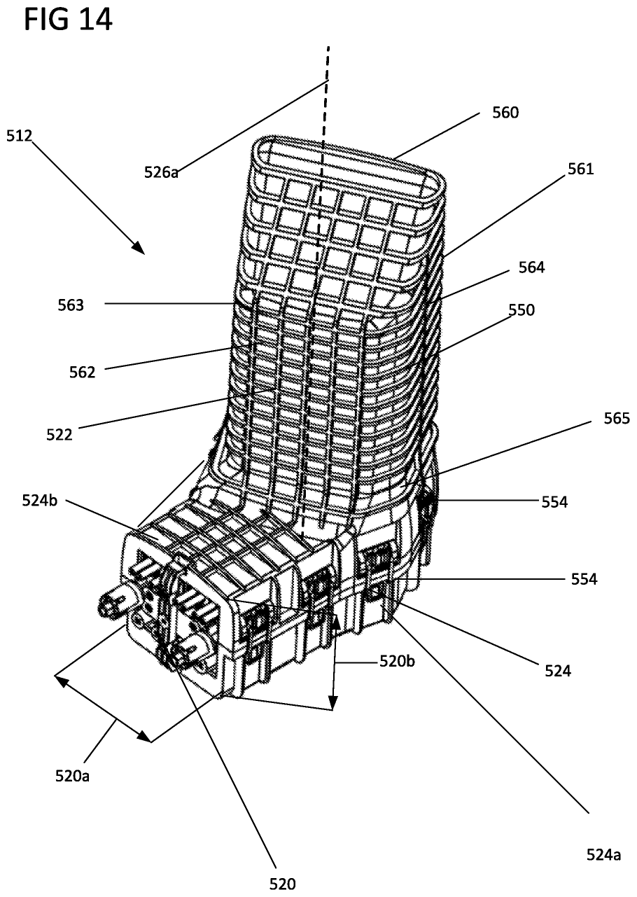

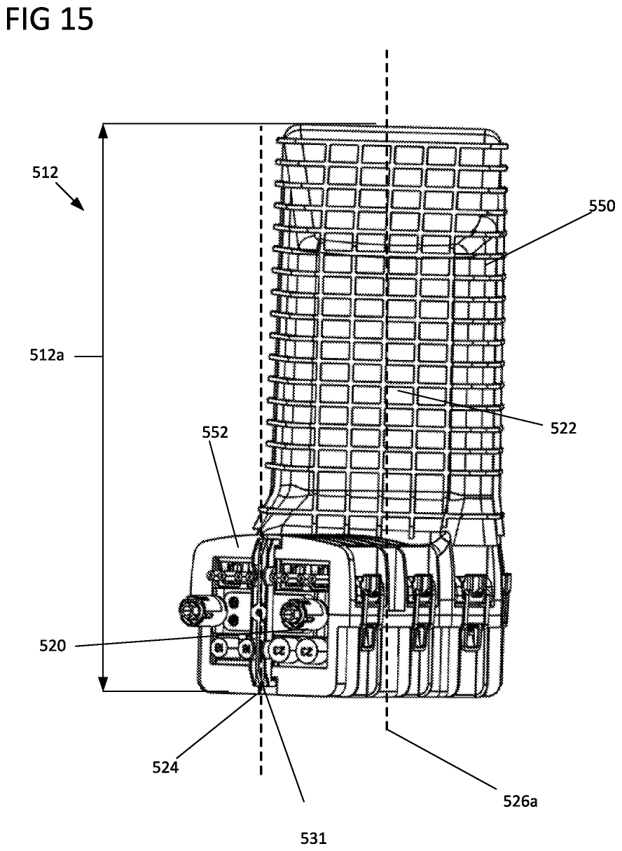

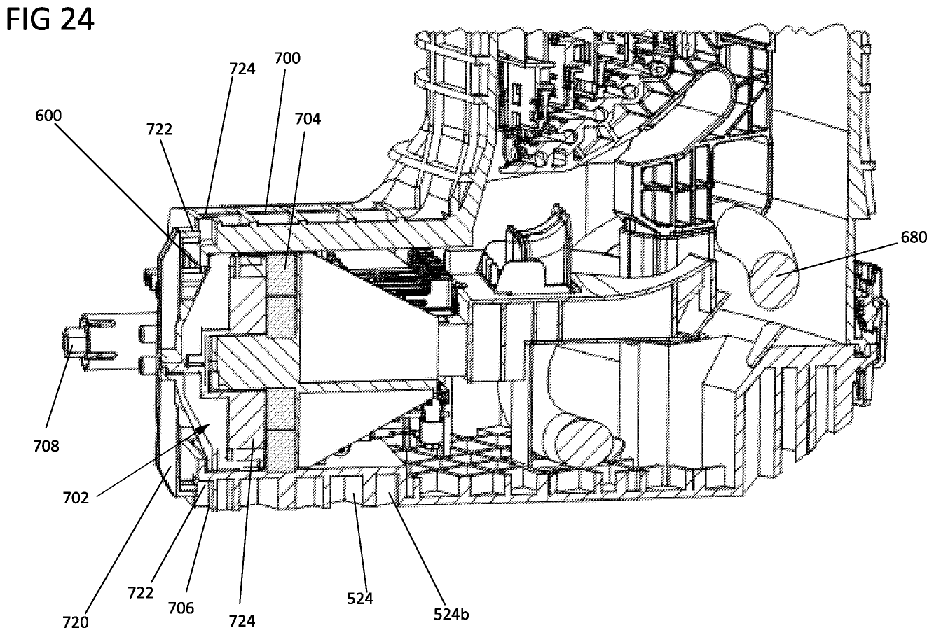

Referring now to FIGS. 13-19, another telecommunications enclosure 500 in accordance with the principles of the present disclosure is shown. The telecommunications enclosure includes a housing 512 (e.g., a terminal housing). The housing 512 includes a cover 522 (e.g., a dome) and a base 524. At least a portion of the base 524 is detachable from the remainder of the housing 512. The cover 522 defines a longitudinal axis 526a and the housing 512 defines a length 512a that extends along the longitudinal axis 526a between a top end 527 and a bottom end 529 of the housing 512. The base 524 is at the bottom end 529 of the housing 512. The housing includes a side cable entrance 520 that defines a cable pass-through orientation 523 that extends along a first reference plane 521 that extends across the longitudinal axis 526a. The side cable entrance 520 defines a major cross dimension 520a and the major cross dimension 520a is measured along the first reference plane 521. The side cable entrance 520 also defines a minor dimension 520b perpendicular relative to the major dimension 520a. The minor dimension 520b is perpendicular with respect to the first reference plane 521 and parallel to the longitudinal axis 526a. Cables entering and exiting the enclosure through sealed cable pass-through locations of the side cable entrance 520 extend along the cable pass-through orientation 523 and thus along the first reference plane 521. The cable pass-through locations can be located above and below the first reference plane 521 and can be spaced-apart along the first reference plane 521 (e.g., along the major cross dimension 520a). The cable pass-through locations are locations where cables pass through a cable seal arrangement 600 (e.g., see FIG. 24) of the enclosure 500 incorporated as part of the side cable entrance 520. The first reference plane 521 is depicted as a horizontal plane that bisects the side cable entrance 520.

As depicted the first reference plane 521 is perpendicular relative to the longitudinal axis 526a. In other examples, the side cable entrance and the cable pass-through orientation can be configured such that first reference plane is angled at an angle A in the range of 60-120 degrees relative to the longitudinal axis 526a, or in the range of 80-100 degrees relative to the longitudinal axis 526a, or in the range of 85-95 degrees relative to the longitudinal axis 526a.

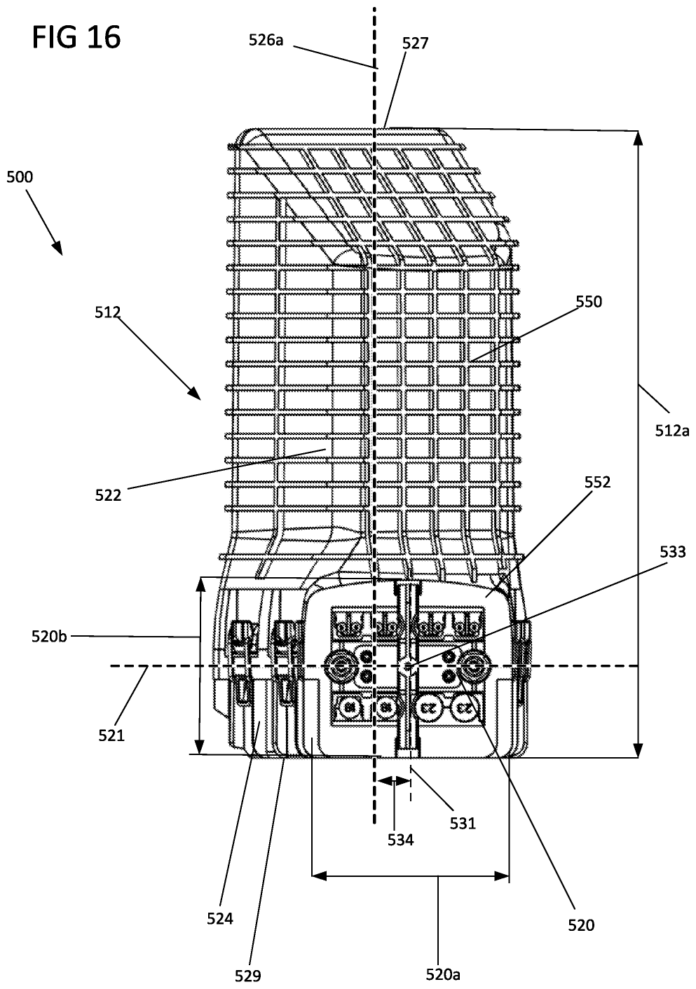

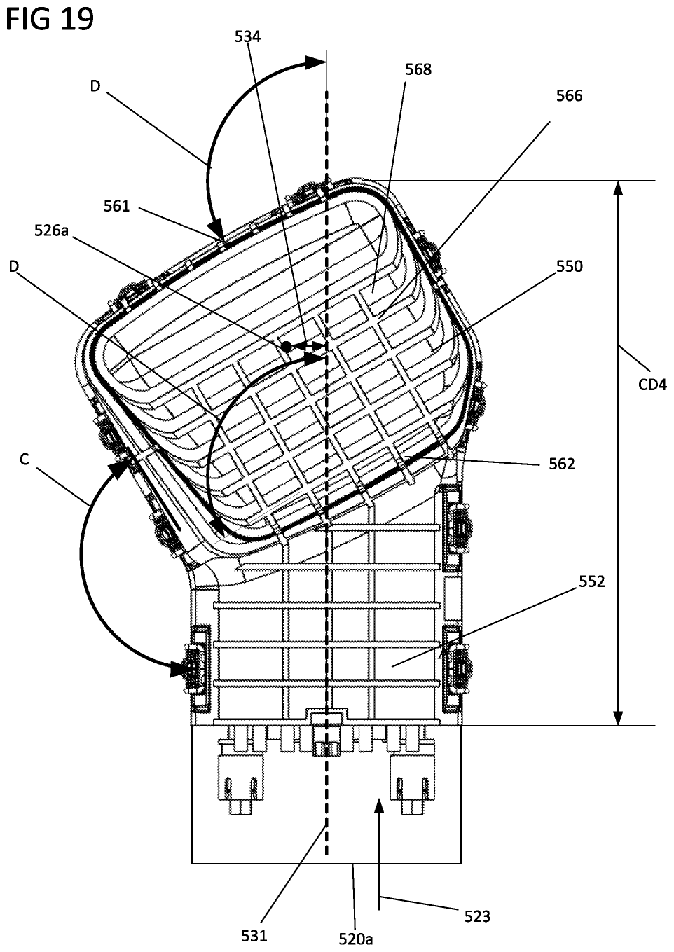

The side cable entrance 520 is also shown bisected by a second reference plane 531 that extends along the minor dimension 520b of the side cable entrance 520. The second reference plane 531 is depicted as a vertical plane. A centerline 533 of the side cable entrance 520 is parallel to the first and second reference planes 521, 531 and is located at the intersection point of the major and minor dimensions 520a, 520b of the side cable entrance 520. The side cable entrance 520 is angled relative to the cover 522 (e.g., oriented at an oblique angle when viewed from an orientation along the longitudinal axis 526a) such that the second reference plane 531 as well as the centerline 533 do not intersect the longitudinal axis 526a (see FIGS. 16 and 19). Instead, the second reference plane 531 and the centerline 533 are offset from the longitudinal axis 526a by an offset distance 534.

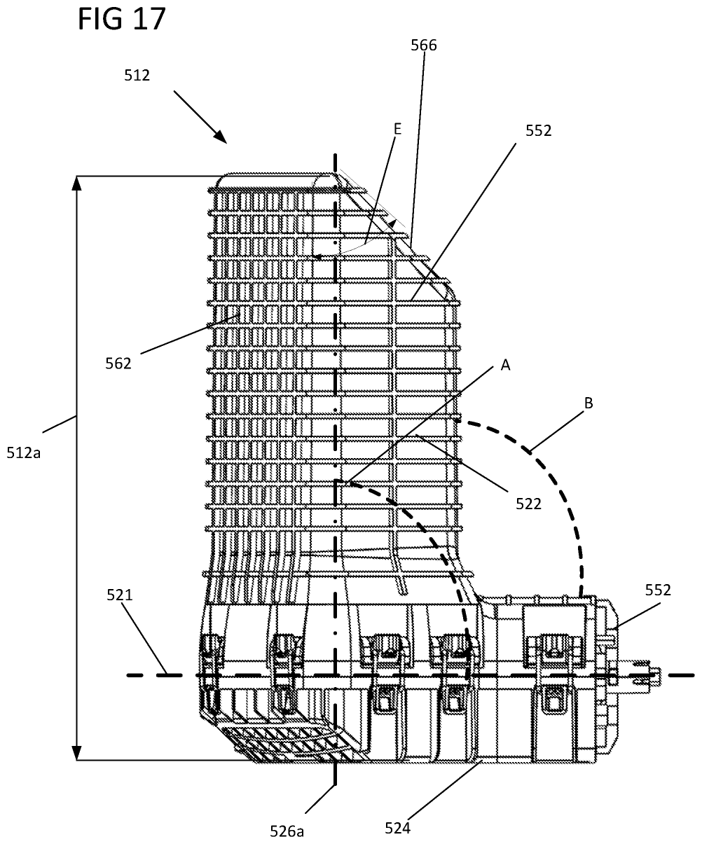

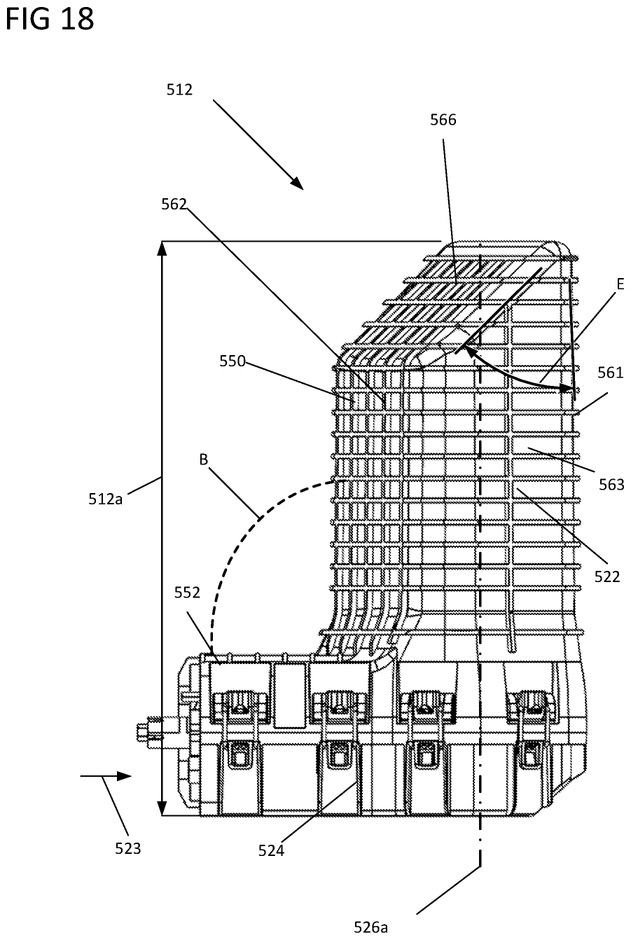

The housing 512 of the enclosure 500 has a main housing body 550 that is elongate along the length 512a which extends along the longitudinal axis 526a of the main housing body 550 between top and bottom ends 527, 529. The side cable entrance 520 is located adjacent the bottom 529. Cables entering the enclosure 500 through the side cable entrance 520 extend along the cable entrance/pass-through orientation 523 that is not parallel to the longitudinal axis 526a. The cable entrance location 520 is defined by a cable entrance extension 552 (e.g., a sleeve) that contains the cable sealing arrangement 600. The cable entrance extension 552 projects laterally from the main housing body 550 adjacent the bottom end 529 of the main housing body 550. The cable entrance extension 552 projects outwardly from the main housing body 550 along the cable pass-through orientation 523. In one example, a majority of the length 512a of the main housing body 550 is defined by the cover 522 (e.g., the dome) that removably mounts to the base 524 of the enclosure, and a minority of the length 512a is defined by the base 524. In one example, from a side view (see FIGS. 17 and 18), the cable entrance extension 552 is angled at an angle B in the range of 60-120 degrees relative to the main housing body 550, or in the range of 80-100 degrees relative to the main housing body 550, or in the range of 85-95 degrees relative to the main housing body 550, or is perpendicular relative to the main housing body 550. In one example, from an end view along the longitudinal axis 526a of the main housing body 550 (see FIG. 19), the cable entrance extension 552 is angled at and angle C in the range of 100-175 degrees relative to the main housing body 550, or in the range of 110-170 degrees relative to the main housing body 550, or in the range of 120-170 degrees, or in the range of 135-165 degrees relative to the main housing body 550. Similar to the telecommunications enclosures discussed above, the housing 512 of the enclosure includes a cross-dimension CD4 that extends along the plane 531. The cross-dimension CD4 is measured at the side cable entrance 520. The length 512a is longer that the cross-dimension CD4.

In the depicted example, the base 524 includes a lower portion 524a and an upper portion 524b secured together by latches 554 positioned about the perimeter of the base 524. When the lower and upper portions 524a, 524b of the base 524 are secured together, they cooperate to enclose an interior of the base 522. As described with respect to previous examples, a seal such as a gasket can provide environmental sealing at the interface between the lower and upper portions 524a, 524b of the base 524 about the perimeter of the base 524. In the depicted example, the upper portion 524b is unitarily formed with the cover 522. In other examples, the upper portion 524b can be a separate piece from the cover 522 and can be secured to the cover by a clamp or other fastening structure similar to the example depicted at FIG. 6.

The cover 522 is depicted as a dome having a closed top end 560 and a bottom end 565 that attaches to the base 524 (e.g., either unitarily or by a detachable connection). The cover 522 includes first and second opposite sides 561, 562 interconnected by third and fourth opposite sides 563, 564. The sides 561-564 extend between the closed top and 560 and the open bottom and 562. In the depicted example, the first and second opposite sides 561, 562 are generally perpendicular with respect to the third and fourth opposite sides 563, 564 with corner transitions between the sides being rounded. As shown at FIG. 19, the first and second opposite sides 561, 562 are intersected by the vertical second reference plane 531 which bisects the cable entrance extension 552. An oblique angle D is defined between the second reference plane 531 and the first and second opposite sides 561, 562. In one example, the oblique angle D is in the range of 30-80 degrees or in the range of 40-70 degrees. Similarly, an end face 566 of the side cable entrance 520 is depicted oriented at an oblique angle E relative to a face defined by the first side 561 of the cover 522. The oblique angle E can be in the range of 10-60 degrees or in the range of 20-50 degrees. The top end 560 of the cover 522 can have a canted configuration defined by sloped wall 568 in alignment with the first side 561 of the cover 522. In one example, the cant angle at the top of the cover 522 can be in the range of 30 to 60 degrees and the slope surface 568 can extend across a majority of a depth of the cover 522. In the depicted example, the depth of the cover extends between the third and fourth opposite sides 563, 564.

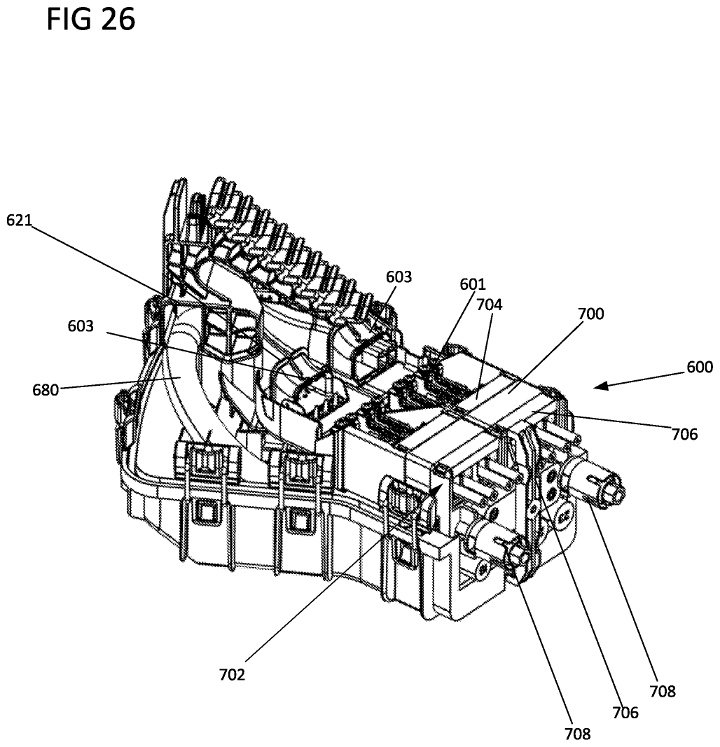

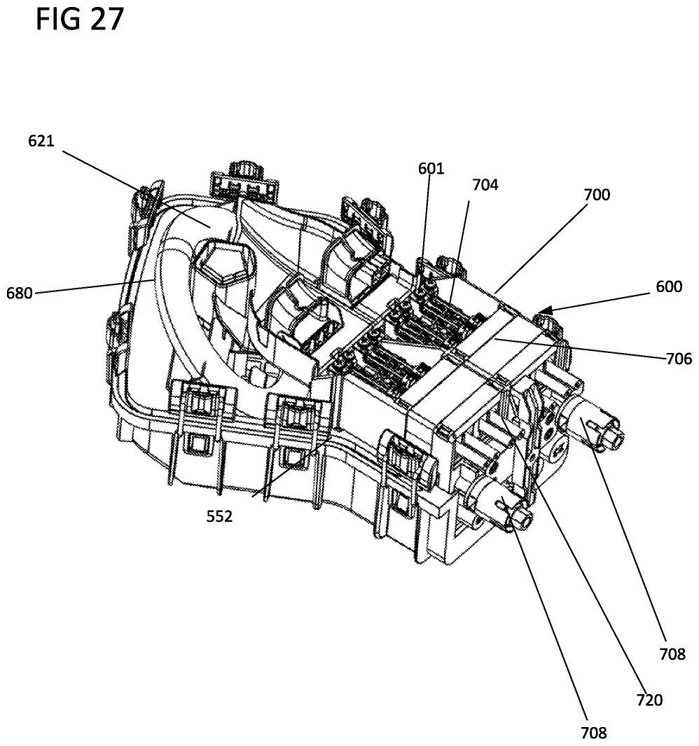

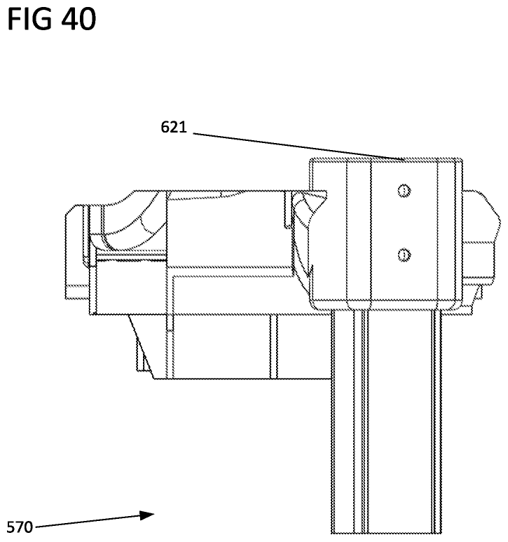

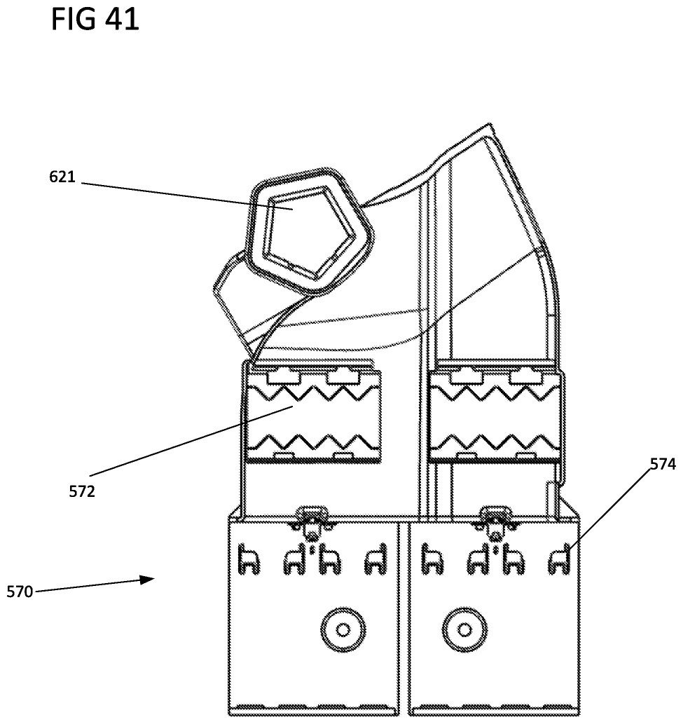

Similar to previous examples, enclosure 500 includes a base tray 570 (see FIGS. 26, 27 and 39-41) positioned in the base 524. The base tray 570 extends through the base 524 along the first reference plane 521. Similar to the previous examples, the base tray 570 can be configured to allow various components to be secured thereto. For example, the cable sealing arrangement 600 can be secured to one end of the base tray 570 so as to be positioned adjacent the outer end of the cable entrance extension 552. Cable anchoring structures 601 such as cable clamps, cable tie locations or other structures can be also supported on the base tray 570 at an inner side of the cable sealing arrangement 600. Management structures 603 (FIG. 26) can be used to bundle buffer tubes of the cables routed from the cable anchoring structures 601 to a fiber management tray arrangement. In other examples, effective routing of the buffer tubes to the fiber management tray arrangement can be accomplished without using the routing structures. The cable management structures 603 can be mounted to the base tray 570 at mounting locations 572. The cable anchoring structures 601 are secured to the base tray at securing locations 574 (FIG. 39).

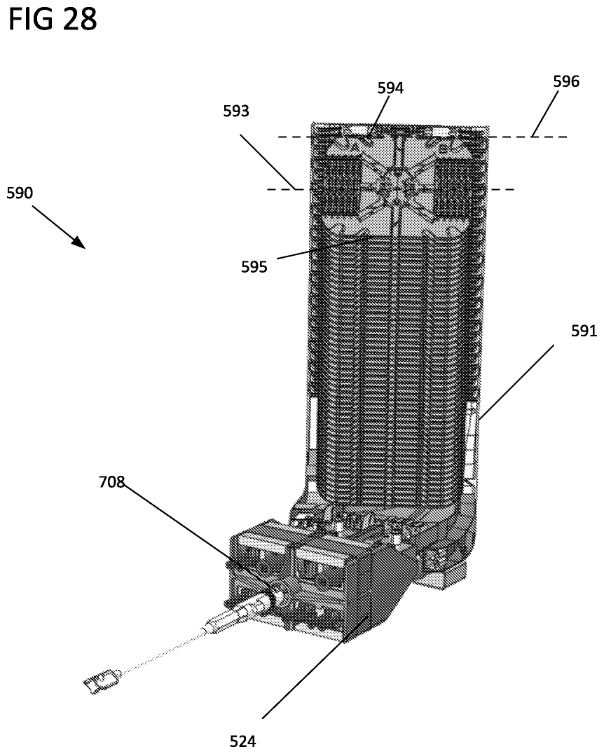

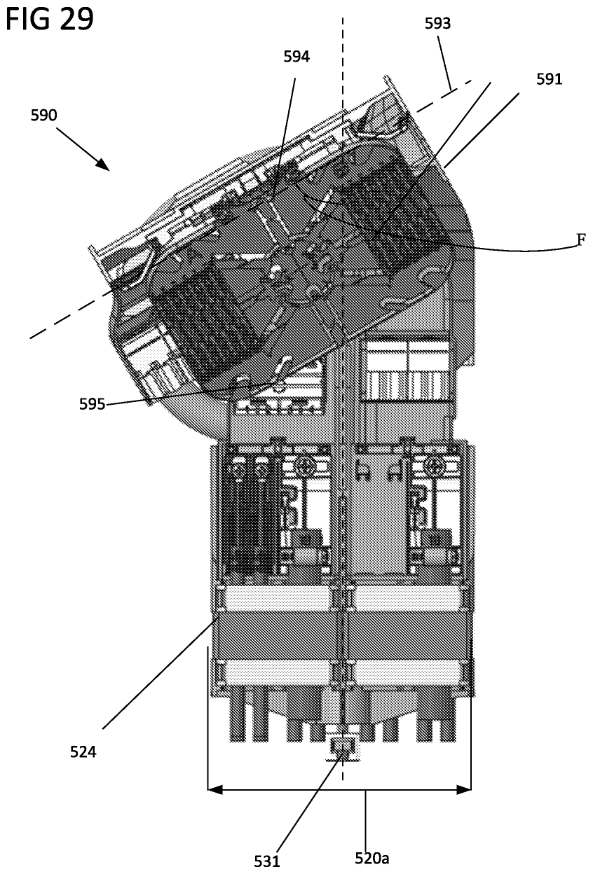

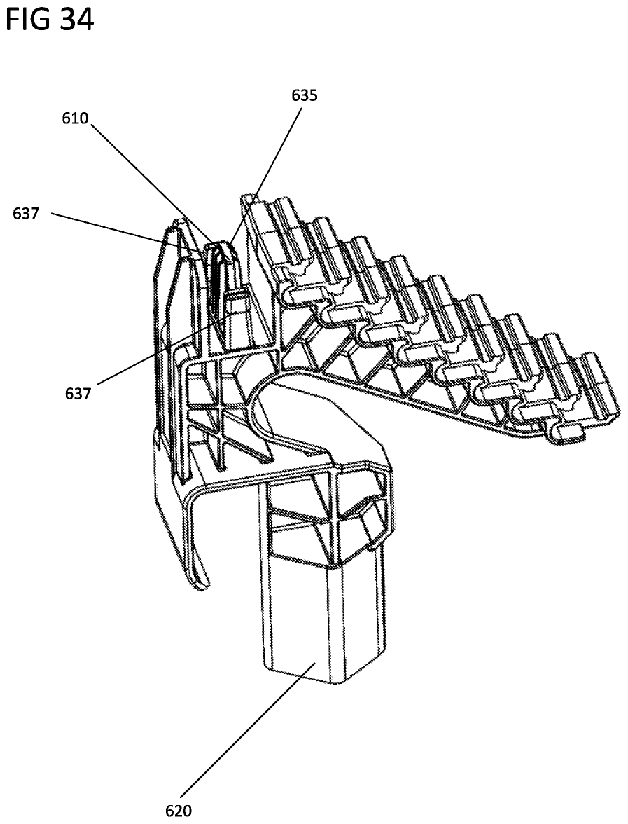

It will be appreciated that the enclosure 500 can be compatible with different types of fiber management trays and tray towers. The base tray 570 can be configured to accommodate different styles of tray towers depending upon customer preference. For example, FIG. 20 shows a first fiber management tray configuration 580 mountable to the base tray 570 and FIGS. 28 and 29 show a second fiber management tray configuration 590 mountable to the base tray 570. It will be appreciated that each of the first and second fiber management tray configurations 580, 590 can include a mechanical connection interface adapted to mate with a corresponding mechanical connection interface of the base tray 570. For example, each of the first and second fiber management tray configurations 580, 590 can include a tray mounting tower (see FIG. 34) having a first mechanical interface 620 configured to interconnect with a corresponding (e.g., mating) second mechanical interface 621 defined by the base tray 570. In one example, the first mechanical interface 620 includes a male feature such as a projection having a polygonal (e.g., hexagonal) shape adapted to be received within a complementary female feature defined by the second mechanical interface 621 such as a mating polygonal receptacle.

The first fiber management tray configuration 580 includes a tray tower 581 having a plurality of tray pivotal mount locations 624 arranged in a stepped configuration. The tray configuration 580 includes a plurality of fiber management trays 582 each having a major dimension 583 that extends between upper and second lower ends 584, 585. The fiber management trays 582 are elongate along the major dimension 583. The lower ends 585 of the fiber management trays 582 are pivotally connected to the tray tower 581 at pivot axes 586 located at the pivotal mount locations 624 so that the trays can be pivoted relative to one another about their lower ends to facilitate accessing each of the trays. The trays 582 can include pivot members that snap within receptacles defined at the pivotal mount locations 624. The pivot axes 586 are oriented at an oblique angle F relative to the second reference plane 531. In one example, the oblique angle F is in the range of 30-80 degrees or in the range of 40-70 degrees. The lengths of the trays 582 extend upwardly from the tray pivotal mount locations of the tray tower 581 when the trays are stored within the enclosure. When in the enclosure 500, the upper ends of the trays are vertically staggered so as to transition in height with the inner surface of the sloped wall 568. Thus, the canted configuration of the top of the cover 522 is configured to generally match or accommodate a similar angled shape defined by the upper region of the fiber management tray configurations 580.

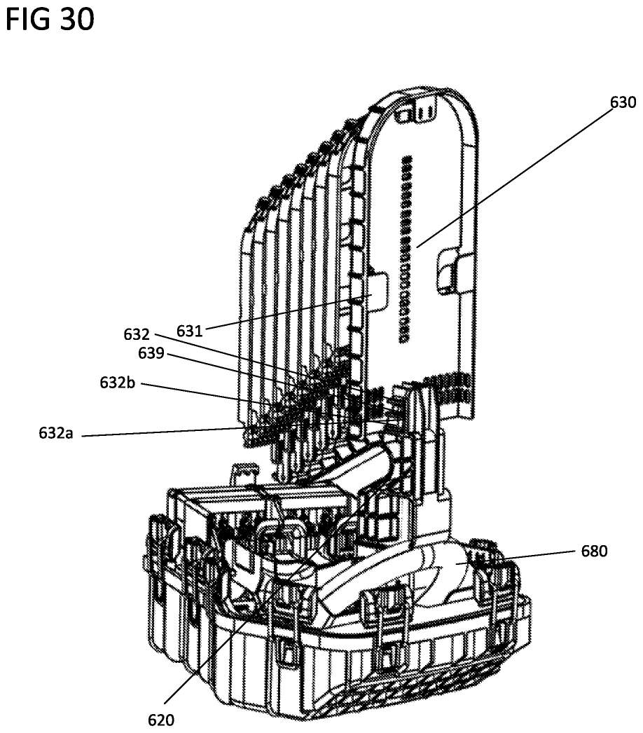

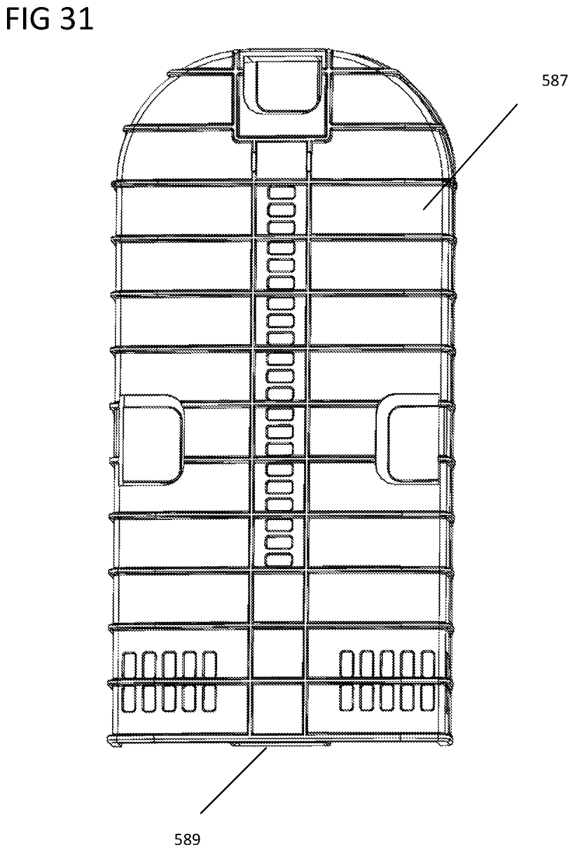

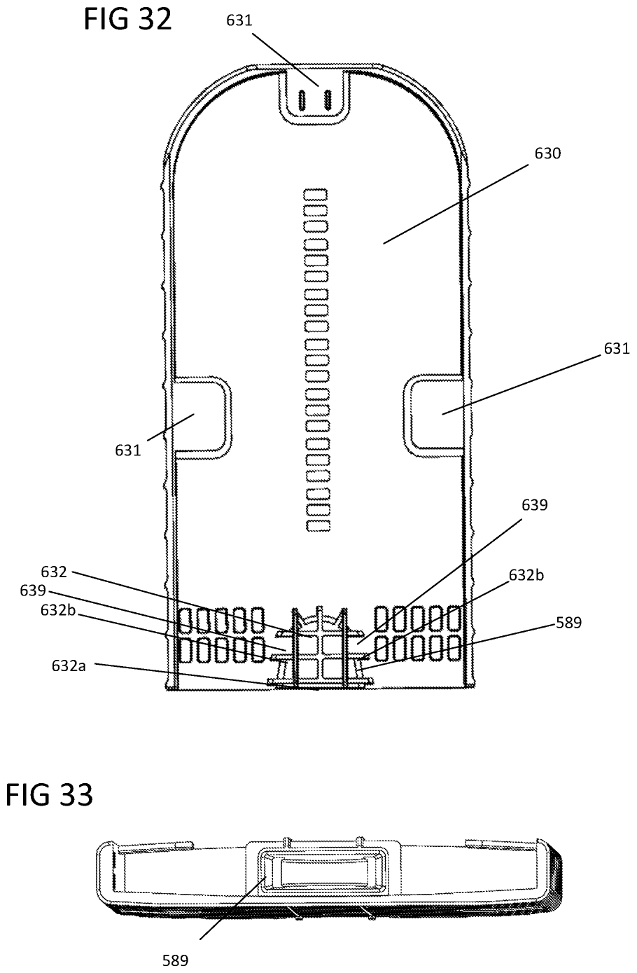

In one example, the first fiber management tray configuration 580 can include a fiber management module 587 (e.g., a basket) (see FIGS. 30-33) adapted for storing excess fiber routed to the fiber management tray configuration 580 in a loop behind the tray stack. In some examples, the fibers are routed in a u-turn configuration (e.g., a single 180 degree turn adjacent the top end of the module 587) within the module 587 to provide excess fiber length for working on splices or other operations on a corresponding one of the trays 582 while the tray 582 is disconnected from the tray tower (e.g., laid on a working table). In certain examples, the fibers routed within the fiber management module 587 are protected within over-tubes (e.g., buffer tubes, mesh tubes, furcation tubes) that can be anchored to the module 587 (e.g., by tie-wraps) once work on the corresponding tray has been completed. The over-tubes are routed from the module 587 to corresponding ones of the trays 582 where ends of the over-tubes are attached to the trays. The optical fibers (e.g., coated optical fibers such as optical fibers coated with one or more layers of acrylate having outer diameters of about 250 micron or 200 microns) extend beyond the over-tubes onto the trays such that the fibers routed on the trays 582 are not protected within over-tubes but instead are protected by the trays 582.

The fiber storage module 587 can be mounted with an open side 630 of the fiber storage module 587 facing toward the trays 582 or away from the trays 582. The fiber storage module 587 can include tabs 631 for retaining optical fibers looped within a cavity defined at the open side 630. In one example, the fiber storage module 587 as a lower mechanical connection interface 589 (e.g., a female connection interface such as a socket 632) that engages a complementary mechanical connection interface 610 (e.g., a male connection interface such as a projection) of the tray tower 581 (see FIG. 34). In one example, the lower mechanical connection interface 589 and the complementary mechanical connection interface 610 can couple together via a snap-fit connection provided by latches or other resilient latching features. In the depicted example, the socket 632 includes a central region/pocket 632a for receiving a main projection 635 of the connection interface 610 and side regions/pockets 632b for receiving latches 637 of the connection interface 610. The latches 637 can snap within side openings 639 defined within walls of the side regions/pockets 632b.

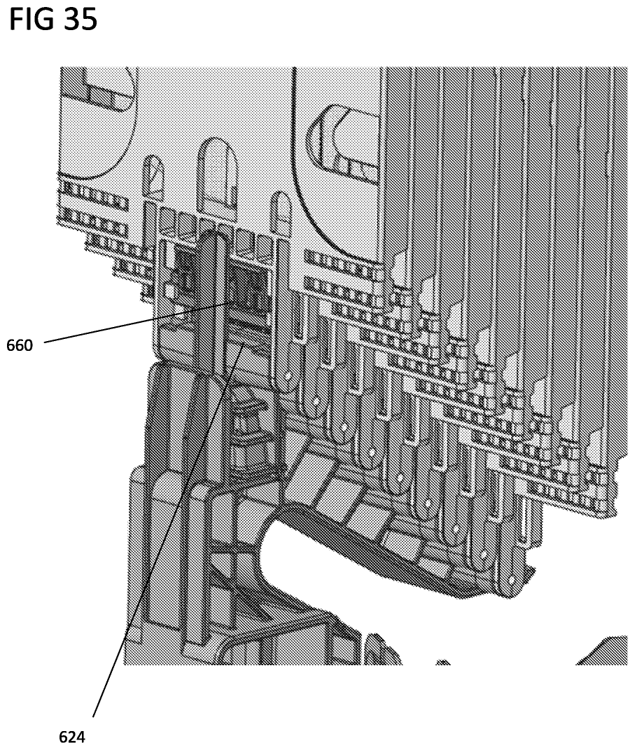

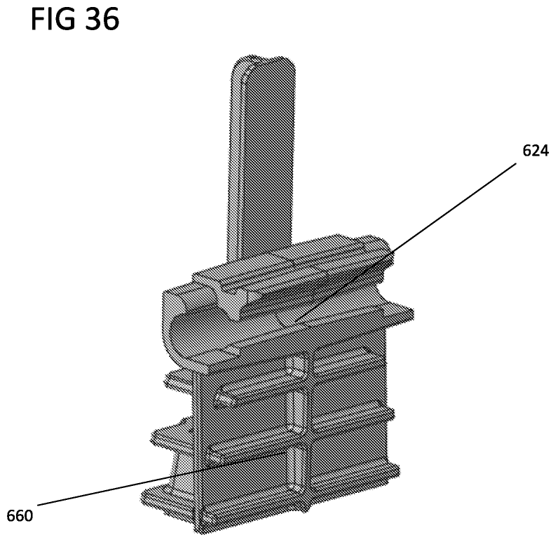

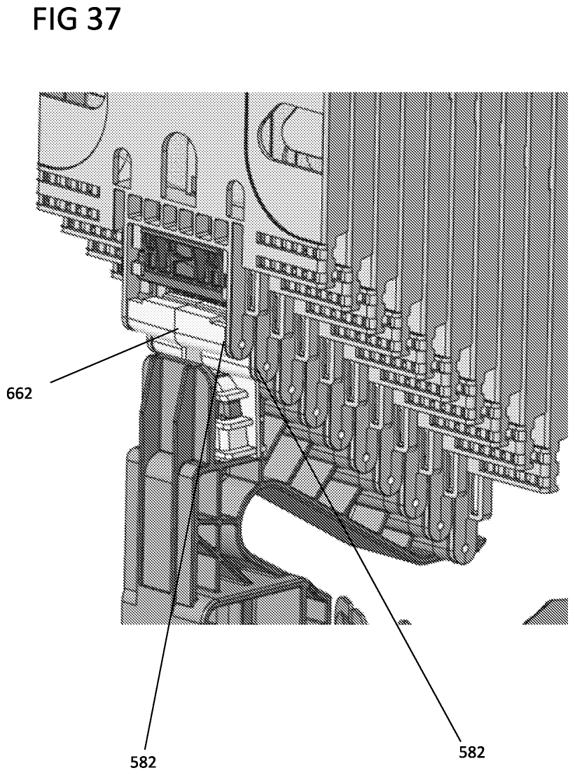

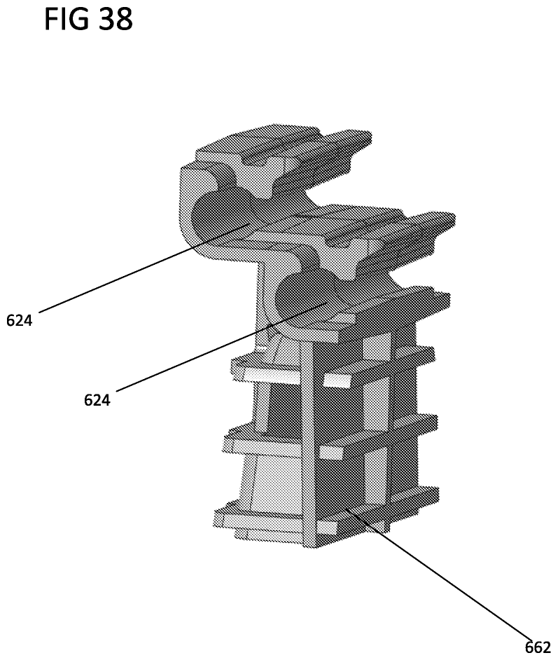

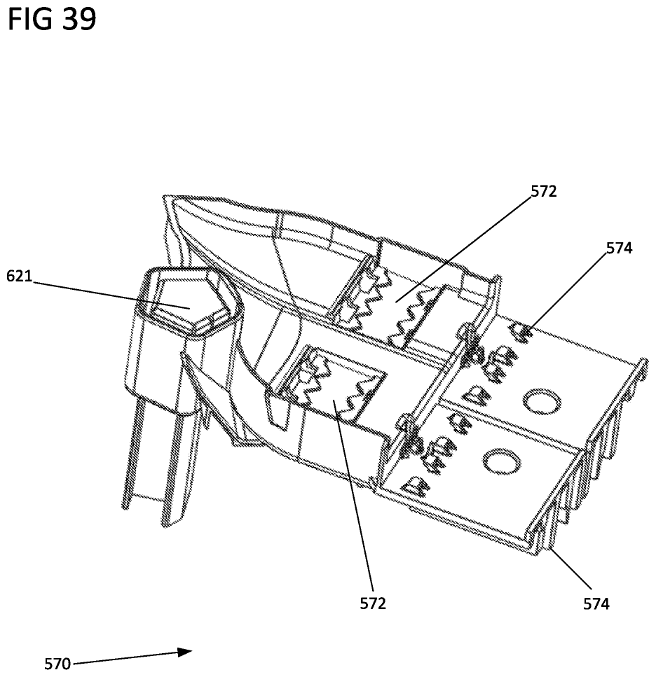

To increase the tray capacity of the first fiber management tray configuration 580, the fiber storage module 580 can be replaced with a tray expansion adapter configured for allowing one or more additional trays 582 to be added to the tray tower 581. FIGS. 35 and 36 show an example tray expansion adapter 660 having one tray pivotal mount location 624 for allowing one additional tray 582 to be added to the tray tower 581 in place of the fiber storage module 580. FIGS. 37 and 38 show another example tray expansion adapter 662 having to tray pivotal mount locations 624 for allowing two additional trays 582 to be added to the tray tower 581 in place of the fiber storage module 580. Each of the tray expansion adapters 660, 662 includes the same mechanical connection interface 589 provided at the lower end of the fiber storage module 587 such that each of the tray expansion adapters 660, 662 can individually be mounted at the mechanical connection interface 610 of the tower 581 by the same type of snap-fit connection used to secure the fiber storage module 587 to the tower 581.

The enclosure 500 also includes a loop storage region defining a loop storage path 680 located at least partially beneath the base tray 570 and the tray tower 581. The loop storage path can be defined by walls, guides, bend radius limiters and other components integrated with the base, the base tray 570, and/or the tray tower 581. In one example, the loop storage path 680 is adapted for storing uncut buffer tubes from a feeder cable and a loop configuration within the base 524. In some examples, the loop storage path 680 is disposed fully beneath the base tray 570. In other examples, the loop storage path 680 extends at least partially above the base tray 570. In the depicted example, the loop storage path 680 is aligned along a plane that is upwardly angled relative to a bottom of the base 524. In an example, the loop storage path 680 extends beneath the base tray 570, then upwardly past the base tray 570, then behind the second mechanical interface 621, then down past the base tray 570 again to form a loop.

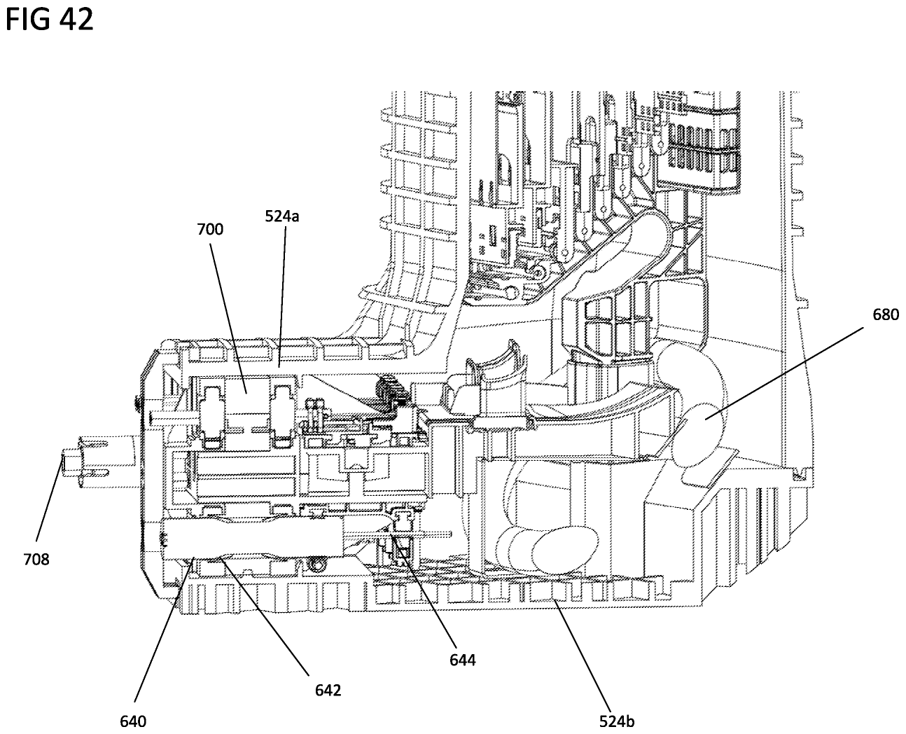

Feeder cables 640 can be routed into the enclosure 500 through the side cable entrance 520. In one example, the feeder cables 640 are routed through a lower portion of the cable sealing arrangement 600 position within the side cable entrance. A given feeder cable 640 can have a first cable section that enters the enclosure 500 through the side cable entrance 520 and a second cable section that exits the enclosure 500 through the side cable entrance. Within the enclosure 500, a jacket 642 of the feeder cable 640 can be stripped along a predetermined length to expose buffer tubes 644 of feeder cable 640 (see FIG. 42). Jacket portions of the first and second cable sections can be anchored to the base tray 570 inside the cable sealing arrangement 600. The exposed buffer tubes 644 that are desired to be passed-through the enclosure 500 without accessing the optical fibers within the buffer tubes 644 are routed from the anchoring locations to the loop storage region where the buffer tubes 644 are looped along the loop storage path 680. The exposed buffer tubes 644 that are desired to be accessed, are cut, and the buffer tubes are routed to the left side of the first fiber management tray configuration 580. The buffer tubes 644 can be routed directly to the individual trays 582 of the tray arrangement or can be routed first to the fiber storage module 587 and then to the individual trays 582. In certain examples, at the fiber storage module, the buffer tubes 644 can be replaced with more flexible over-tube materials. The buffer tubes 644 or the other over-tube materials can be anchored to the individual trays 582 and the optical fibers can be routed out of the buffer tubes 644 or other over-tubes on to the trays 582 for splicing to optical fibers corresponding to branch cables or drop cables. The branch cables or drop cables are routed into the enclosure 500 through the side cable entrance 520 and are sealed at the cable sealing arrangement 600 (e.g., preferably at an upper portion of the sealing arrangement). The branch cables or drop cables can be anchored at the cable anchoring location located at an inner side of the cable sealing arrangement 600. From the cable anchoring location, buffer tubes 644 corresponding to the drop cables or branch cables can be routed to the right side of the first fiber management tray configuration 580. For example, the buffer juice can be routed to individual trays 582 of the tray configuration 580. At the individual trays 582, the optical fibers of drop cables or branch cables can be routed out of the corresponding buffer tubes 644 and accessed for splicing to corresponding fibers of the feeder cables 640.

Referring to FIGS. 28 and 29, the second fiber management tray configuration 590 includes an upright tray tower 591 having a plurality of tray pivotal mount locations 624 that are vertically spaced apart from one another along the upright tray tower 591. The second fiber management tray configuration 590 includes a plurality of trays 592 pivotally connected to tray tower 590 at the pivotal mount locations 624. The trays 590 are elongate along major axes 593 and have opposite upper and lower sides 594, 595 that are parallel to the major axes 593. The upper sides 594 of the trays 590 are pivotally connected to the tray tower 591 at the pivotal mount locations 624. The trays 590 are pivotally movable relative to one another and relative to the tray tower 590 about pivot axes 596. The pivot axes 593 are oriented at the oblique angle F relative to the second reference plane 531 when the tray configuration 580 is within the housing 512 of the enclosure 500.

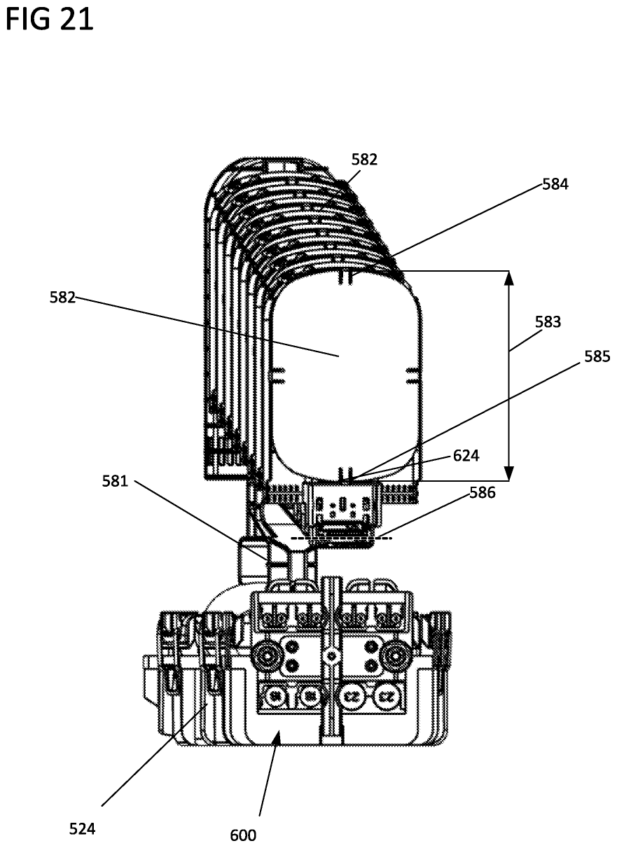

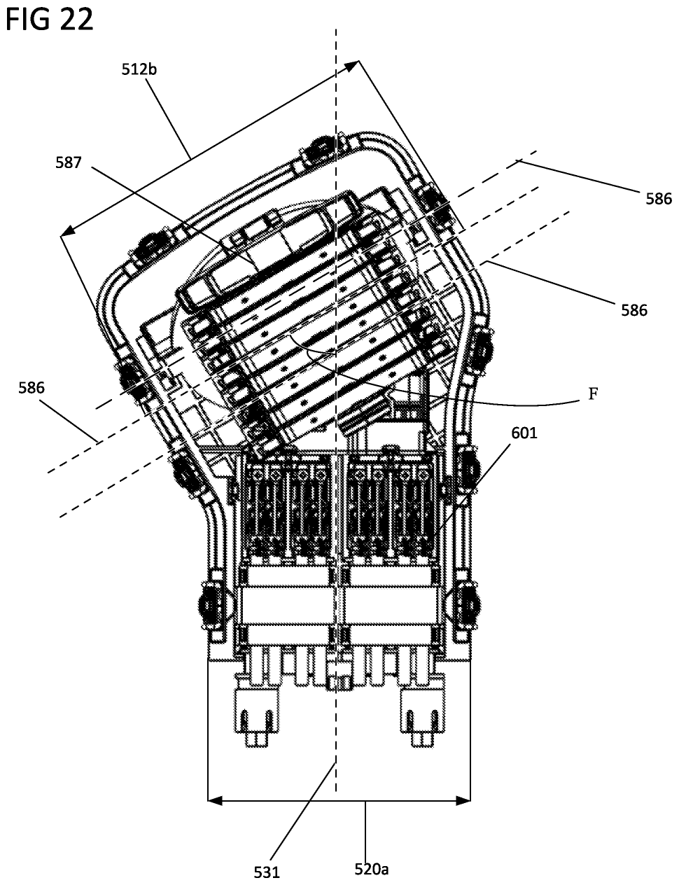

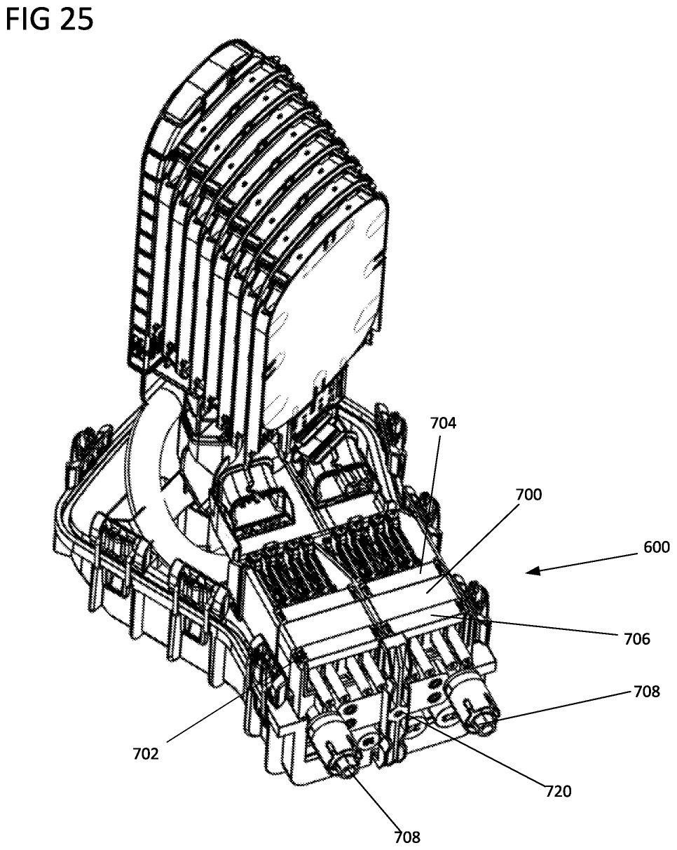

Referring to FIGS. 20-27, the cable sealing arrangement 600 includes a volume of sealing material 700 (e.g., sealing gel) contained within the cable entrance extension 552. The sealing material 700 can include separate blocks or pieces of gel that can be separated from one another to allow cables to pass between the pieces of gel and be sealed by the gel when the gel is pressurized. The cable sealing arrangement 600 includes an actuator 702 for use in pressurizing the volume of sealing material 700 within the cable entrance extension 552 to provide sealing around cables routed through the sealing material 700 and also to provide sealing between the sealing material 700 and the interior of the cable entrance extension 552. The actuator 702 includes inner and outer pressurization structures 704, 706 (e.g., walls, gel containment structures, etc.) between which the volume of sealing material 700 is axially captured. The inner and outer pressurization structures and 704, 706 can include predefined openings corresponding to different cable pass-through locations for use in passing cables through the cable sealing arrangement 600. Triggers 708 are used to force the inner and outer pressurization structure 704, 706 axially together to pressurize the volume of sealing material 700 between the inner and outer pressurization structures 704, 706. The triggers 708 can be spaced-apart from one another along the major dimension of the cable entrance extension. When the volume of sealing material 700 is pressurized, the sealing material 700 flows within the volume of space axially between the inner and outer pressurization structures 704, 706 to conform to the shape of cables routed through the ceiling arrangement, to conform to the inner shape of the cable entrance extension 552 and to fill any voids. In certain examples, the triggers 708 include threaded members configured to force the inner and outer pressurization structures 704, 706 toward one another when the threaded members are rotated in a first rotational direction and configured to move the inner and outer pressurization structures 704, 706 axially apart when the threaded members are rotated in an opposite second rotational direction. FIG. 28 shows an alternative actuator having only one trigger that is centrally located relative to the cable sealing arrangement 600.

As previously described, the base 524 includes upper and lower portions 524a, 524b that are secured together by latches 554. It will be appreciated that when the cable sealing arrangement 600 is pressurized, internal force is applied against the interior surface of the cable entrance extension 552 that tends to force the upper and lower portions 524a, 524b of the base 524 apart from one another. It will be appreciated that upon pressurization, the latches 554 are strong enough to resist the internal gel pressure and retain the upper and lower portions 524a, 524b together. However, it is undesirable to unlatch and separate the upper and lower portions 524a, 524b when the cable sealing arrangement 700 is pressurized. To prevent this from happening, the cable sealing arrangement 700 includes a retainer 720 that engages the upper and lower portions 524a, 524b of the base 524 when the cable sealing arrangement 700 is pressurized to prevent the upper and lower portions 524a, 524b from separating from one another. In one example, the retainer 720 is carried with the outer pressurization structure 706 and includes retaining portions 722 (e.g., fingers, tabs, interlocks, etc.) that engage the upper and lower portions 524a, 524b when the cable sealing arrangement 700 is pressurized, and that are disengaged from the upper and lower portions 524a, 524b when the cable sealing arrangement 700 is not pressurized. FIG. 23 shows the cable sealing arrangement 700 not pressurized and depicts the retainer 720 disengaged from the upper and lower portions 524a, 524b. FIG. 24 shows the cable sealing arrangement 700 pressurized and depicts the retainer 720 engaged with the upper and lower portions 524a, 524b to prevent the base 524 from being opened while the cable sealing arrangement 700 is pressurized. It will be appreciated that the outer pressurization structure 706 and the retainer 720 move toward the upper and lower portions 524a, 524b when the triggers 708 are rotated in the first direction to pressurize the cable sealing arrangement 700, and that the outer pressurization structure 706 and the retainer 720 move away from the upper and lower portions 524a, 524b when the triggers 708 are rotated in the second direction to de-pressurize the cable sealing arrangement 700. When the retainer 720 is in a retaining position, the retaining portions 722 fit within corresponding notches 724 defined by the upper and lower portions 524a, 524b of the base 524.

Examples of a telecommunications enclosure with examples trays, cable anchoring units, and cable sealing units is described in PCT International application No. PCT/US2019/017904, entitled “SEALED CLOSURE WITH FIBER OPTIC ORGANIZER,” filed Feb. 19, 2019, and having Attorney Docket No 02316.7469WOU1, the disclosure of which is hereby incorporated by reference in its entirety.

From the forgoing detailed description, it will be evident that modifications and variations can be made without departing from the spirit and scope of the disclosure.

1. A telecommunications enclosure comprising:
a housing including a dome and a base positioned at one end of the dome, at least a portion of the base being detachable from a remainder of the housing, the dome defining a longitudinal axis, and the housing defining a length that extends along the longitudinal axis;
the housing including a side cable entrance defined at least in part by the base, the side cable entrance defining a cable entrance axis aligned in a reference plane that extends across the longitudinal axis; and
the housing defining a cross-dimension that is perpendicular to the longitudinal axis, the cross-dimension being measured at the side cable entrance and the length of the housing being longer than the cross-dimension.

2. The telecommunications enclosure of claim 1, wherein the length is at least 1.5, or 2 or 3 times as long as the cross-dimension.

3. The telecommunications enclosure of claim 1, wherein the reference plane is perpendicular to the longitudinal axis.

4. The telecommunications enclosure of claim 1, wherein the housing includes a sleeve defining the side cable entrance, and wherein the sleeve includes a sleeve passage containing a cable sealing unit including cable sealing gel.

5. The telecommunications enclosure of claim 4, wherein the sleeve has an inner profile defining the sleeve passage, the inner profile having a major dimension and a minor dimension perpendicular to the major dimension, the major dimension being at least 30 or 40 or 50 percent as large as the cross-dimension and the major dimension extending along the reference plane.

6. The telecommunications enclosure of claim 1, wherein the dome defines a first volume positioned on a first side of the reference plane and the base defines a second volume on a second side of the reference plane opposite from the first side, wherein a plurality of pivotal splice trays are located in the first volume and a loop-storage manager for storing optical fiber in a coil is located in the second volume.

7. The telecommunications enclosure of claim 6, wherein a base tray extends along the reference plane within the housing, and wherein the base tray includes cable anchoring locations for anchoring cables routed into the housing through the side cable entrance, wherein a tower is supported by the base tray, and wherein the pivotal splice trays are supported by the tower.

8. The telecommunications enclosure of claim 7, wherein the cable sealing unit is coupled to the base tray and includes an actuator for pressurizing a volume of gel of the cable sealing unit within the sleeve.

9. The telecommunications enclosure of claim 4, wherein the sleeve projects laterally outwardly from a main body of the housing which extends along the longitudinal axis, and wherein the sleeve is oriented such that the main body and the sleeve define an oblique angle when viewed along the longitudinal axis.

10. The telecommunications enclosure of claim 7, wherein the enclosure defines a fiber storage loop beneath the base tray and the tower for storing pass-through buffer tubes protecting optical fibers routed through the enclosure which correspond to a feeder cable routed through the enclosure.

11. The telecommunications enclosure of claim 10, further comprising a fiber storage module mounted to the tower above the reference plane for holding excess optical fiber before the fiber is routed to the trays.

12. The telecommunications enclosure of claim 10, wherein the fiber storage loop defines a fiber routing path loop aligned along a plane inclined relative to a bottom of the base.

13. The telecommunications enclosure of claim 7, wherein the reference plane is a first reference plane, wherein a second reference plane perpendicular to the first reference plane bisects the side cable entrance, and wherein the second reference plane is oriented at an oblique angle with respect to pivot axes of the pivotal splice trays.

14. The telecommunications enclosure of claim 7, wherein the reference plane is a first reference plane, wherein a second reference plane perpendicular to the first reference plane bisects the side cable entrance, and wherein the second reference plane is oriented to not intersect the longitudinal axis.

15. The telecommunications enclosure of claim 1, wherein the housing includes a sleeve defining the side cable entrance, wherein the sleeve includes a sleeve passage containing a cable sealing arrangement, wherein the sleeve projects laterally outwardly from a main body of the housing which extends along the longitudinal axis, and wherein the sleeve is oriented such that the main body and the sleeve define an oblique angle when viewed along the longitudinal axis.

16. The telecommunications enclosure of claim 1, wherein the reference plane is a first reference plane, wherein a second reference plane perpendicular to the first reference plane bisects the side cable entrance, wherein a plurality of pivotal fiber management trays are positioned within the dome, and wherein the second reference plane is oriented at an oblique angle with respect to pivot axes of the pivotal fiber management trays.

17. The telecommunications enclosure of claim 1, wherein a tray arrangement including a plurality of pivotal trays is coved by the dome, wherein the tray arrangement includes a tower to which the pivotal trays are pivotally mounted, wherein a fiber storage module is mounted on the tower for allowing fibers to be routed in at least one 180 degree turn before being routed to the pivotal trays, and wherein a fiber loop storage path for storing pass-through buffer tubes of feeder cables extends beneath the tower within the base.

18. The telecommunications enclosure of claim 1, wherein the reference plane is angled 80-100 degrees relative to the to the longitudinal axis.

19. The telecommunications enclosure of claim 18, wherein the housing includes a sleeve defining the side cable entrance, wherein the sleeve includes a sleeve passage containing a cable sealing arrangement, wherein the sleeve projects laterally outwardly from a main body of the housing which extends along the longitudinal axis, and wherein the sleeve is oriented such that the main body and the sleeve define an oblique angle in the range of 130-170 degrees when viewed along the longitudinal axis.

20. The telecommunications enclosure of claim 1, wherein a tray arrangement including a plurality of pivotal trays is coved by the dome, wherein the tray arrangement includes a tower to which the pivotal trays are pivotally mounted, wherein a fiber storage module is non-pivotally mountable at a mounting interface on the tower, wherein the fiber storage module is configured for accommodating excess fiber length of fibers prior to the fibers being routed to the pivotal trays, and wherein the tray arrangement includes a tray expansion adapter that can be mounted at the mounting interface in place of the fiber storage module to allow at least one additional pivotal tray to be pivotally mounted at the tower.

21. The telecommunications enclosure of claim 1, wherein the housing includes a sleeve defining the side cable entrance, wherein the sleeve includes a sleeve passage containing a cable sealing arrangement, and wherein the cable sealing arrangement includes an actuator for pressurizing gel of the cable sealing arrangement within the sleeve.

22. The telecommunications enclosure of claim 21, wherein the sleeve includes a first part and a second part that cooperate to contain the cable sealing arrangement, wherein the actuator includes a retainer that moves toward a retaining position when the actuator is actuated pressurize the gel and moves toward a non-retaining position when the actuator is actuated to de-pressurize the gel, and wherein the retainer prevents the first and second parts from being separated when in the retaining position and allows the first and second parts to be separated when in the non-retaining position.

23.-62. (canceled)
